(19) United States
(12) Patent Application Publication
(10) Pub. No.: US 2026/0069988 A1
(43) Pub. Date: Mar. 12, 2026

(54) METHOD AND ELECTRONIC DEVICE FOR MODIFYING GAME FUNCTION BASED ON DIGITAL ITEM TRANSACTION

(71) Applicant: Draftify, Yuseong-gu (KR)

(72) Inventors: Inyoung LEE, Yuseong-gu (KR); Yongcheol JEONG, Yuseong-gu (KR); Youngtaek OH, Yuseong-gu (KR)

(21) Appl. No.: 19/301,247

(22) Filed: Aug. 15, 2025

(30) Foreign Application Priority Data
Sep. 6, 2024 (KR) 10-2024-0121843
Dec. 11, 2024 (KR) 10-2024-0183279

(51) Int. Cl. A63F 13/86

(52) U.S. Cl. CPC A63F 13/86

(57) ABSTRACT

A method includes receiving a first signal associated with a digital item transaction from a first external electronic device, wherein the digital item transaction corresponds to a first game function of a first game application executed on a second external electronic device, transmitting, in response to receiving the first signal, a second signal associated with the first game function to the second external electronic device, wherein the second signal causes a modification of the first game function of the first game application executed on the second external electronic device, and causing the first external electronic device to output a video streaming of the first game application executed on the second external electronic device, wherein the modification of the first game function is applied in the video streaming of game content of the first game application executed on the second external electronic device.

### CROSS-REFERENCE TO RELATED APPLICATION

This application claims priority to Korean Patent Application No. 10-2024-0121843, filed in the Korean Intellectual Property Office on Sep. 6, 2024, and Korean Patent Application No. 10-2024-0183279, filed in the Korean Intellectual Property Office on Dec. 11, 2024, the entire contents of which are hereby incorporated by reference.

### BACKGROUND

The provision of live streaming services, which conduct real-time broadcasts using a Personal Computer (PC) or smartphone connected to a camera, has been actively underway. For example, a user of a live streaming service (hereinafter, referred to as a streamer) may conduct a personal broadcast using various domestic and international streaming platforms, and a viewer may support the streamer by accessing the corresponding streaming platform to watch the broadcast, participate in chat, or provide a digital item to the streamer.

Meanwhile, sponsorship for a streamer is a means by which a viewer can support the streamer, and the sponsorship may be accomplished when the viewer executes item transactions by providing a quantity of digital items through a streaming platform and uses the digital items in the broadcast being conducted by the streamer. Through such digital item transactions, the streamer may strive to improve the quality of the broadcast, such as by conducting the broadcast with content desired by the viewer (e.g., performing a mission). However, with some item transaction schemes, even if a viewer who made an item transaction informs the streamer of the desired content, the streamer may not conduct the broadcast with the content desired by the sponsor. For example, in the case of a game broadcast, even if a viewer provides a digital item for the purpose of performing a mission in the game, the streamer may just receive the sponsorship and not perform the game mission. Accordingly, the development of a technology that mediates item transactions affecting streaming game content is required.

### SUMMARY

The present disclosure provides a method and an electronic device associated with a modification of a game function based on a digital item transaction for solving the problems as described above.

The present disclosure may be implemented in various ways, including a method, an apparatus (system), and/or a non-transitory computer-readable recording medium storing computer-readable instructions.

A method performed by an apparatus comprising at least one processor may comprise: receiving a first signal associated with a digital item transaction from a first external electronic device, wherein the digital item transaction corresponds to a first game function of a first game application executed on a second external electronic device; transmitting, in response to receiving the first signal, a second signal associated with the first game function to the second external electronic device, wherein the second signal causes a modification of the first game function of the first game application executed on the second external electronic device; and causing the first external electronic device to output a video streaming of the first game application executed on the second external electronic device, wherein the modification of the first game function is applied in the video streaming of game content of the first game application executed on the second external electronic device.

A first object may be displayed overlapping at least part of a screen displaying the video streaming of the game content of the first game application executed on the second external electronic device, and the first object may comprise at least one of: information associated with the digital item transaction; or an indicator indicating the modification of the first game function.

The information associated with the digital item transaction may comprise at least one of identification information of an executing entity associated with the digital item transaction, modification contents of the first game function, or a time duration in which the modification of the first game function is applied.

The first object may be generated by the second external electronic device in response to receiving the second signal.

The method may further comprise: transmitting, in response to receiving the first signal, a third signal associated with the modification of the first game function to a third external electronic device connected to the second external electronic device, wherein the first object is generated by the third external electronic device in response to receiving the third signal.

The game content, of the first game application executed on the second external electronic device, to which the modification of the first game function is applied may be transmitted from the second external electronic device to a third external electronic device.

The method may further comprise: transmitting a third signal associated with the modification of the first game function to the third external electronic device, wherein the first object is generated by the third external electronic device in response to receiving the third signal.

The method may further comprise: transmitting a third signal associated with the modification of the first game function to a fourth external electronic device communicating with the third external electronic device, wherein the first object is generated by the fourth external electronic device in response to receiving the third signal.

Based on a third signal associated with a second digital item transaction being received before receiving the first signal, and before a modification of a second game function corresponding to the second digital item transaction being applied to the game content of the first game application executed on the second external electronic device, the first object may be added to a list including a second object comprising information associated with the second digital item transaction.

Based on the first game function and the second game function being of a same functional type, the first game function and the second game function may be integrated into a third game function of the same functional type having a greater application intensity in an application of the third game function to the first game application executed on the second external electronic device, and instead of adding the first object to the list, the second object previously included in the list may be changed into a third object corresponding to the third game function.

Based on the first game function being a function performed according to a result of voting determined by at least one digital item transaction over a predetermined period of time, the first object comprises contents of the voting.

Based on the first game function being a function performed upon reaching a predetermined amount of digital item transactions together with at least one other digital item transaction, the first object may comprise a currently accumulated amount of digital item transactions.

Based on the modification of the first game function being applied to the game content of the first game application executed on the second external electronic device, identification information of an executing entity of the digital item transaction and contents of the first game function may be displayed in an area adjacent to a user character included in the game content.

The modification of the first game function may comprise modifying the game content by adding a game object having a name corresponding to identification information of an executing entity of the digital item transaction to the game content.

A non-transitory computer-readable recording medium may store computer-readable instructions that, when executed by at least one processor, cause: receiving a first signal associated with a digital item transaction from a first external electronic device, wherein the digital item transaction corresponds to a first game function of a first game application executed on a second external electronic device; transmitting, in response to receiving the first signal, a second signal associated with the first game function to the second external electronic device, wherein the second signal causes a modification of the first game function of the first game application executed on the second external electronic device; and causing the first external electronic device to output a video streaming of the first game application executed on the second external electronic device, wherein the modification of the first game function is applied in the video streaming of game content of the first game application executed on the second external electronic device.

An electronic device may comprise: a communication circuit; a memory; and at least one processor coupled to the communication circuit and the memory and configured to execute computer-readable instructions stored in the memory, wherein the computer-readable instructions, executed by the at least one processor, are configured to cause the electronic device to: receive, via the communication circuit, a first signal associated with a digital item transaction from a first external electronic device, wherein the digital item transaction corresponds to a first game function of a first game application executed on a second external electronic device; in response to receiving the first signal, transmitting, via the communication circuit, a second signal associated with the first game function to the second external electronic device, wherein the second signal causes a modification of the first game function of the first game application executed on the second external electronic device; and causing the first external electronic device to output a video streaming of the first game application executed on the second external electronic device, wherein the modification of the first game function is applied in the video streaming of game content of the first game application executed on the second external electronic device.

According to some aspects of the present disclosure, by mediating digital item transactions that affect streaming game content, it is possible to support the progression of a broadcast with content desired by an executing entity who executes a digital item transaction, and accordingly, it is possible to induce a viewer's digital item transactions and support the improvement of broadcast quality through the improved digital item transaction schemes.

The effects of the present disclosure are not limited to the effects mentioned above, and other unmentioned effects will be clearly understood by those of ordinary skill in the art to which the present disclosure pertains (hereinafter referred to as ‘a person of ordinary skill in the art’) from the description of the claims.

### BRIEF DESCRIPTION OF THE DRAWINGS

Embodiments of the present disclosure will be described with reference to the accompanying drawings described below, wherein like reference numerals refer to like elements, but are not limited thereto.

FIG. 1 is a diagram illustratively showing an electronic device for digital item transaction mediation.

FIG. 2 is a schematic diagram illustrating a configuration in which an information processing system is communicably connected with a plurality of user terminals in relation to data processing.

FIG. 3 is a block diagram illustrating the internal configuration of a user terminal and an information processing system.

FIG. 4 is a diagram for explaining a digital item transaction mediation system in which a game content manipulation module, a game content provision module, a game function linkage module, and a game function display module are included in one device.

FIG. 5 is a diagram for explaining a digital item transaction mediation system in which a game content manipulation module, a game content provision module, and a game function linkage module, and a game function display module are included in different devices.

FIG. 6 is a diagram for explaining a digital item transaction mediation system in which a game content provision module and a game function linkage module, and a game content manipulation module and a game function display module are included in different devices.

FIG. 7 is a diagram for explaining a digital item transaction mediation system in which a game content provision module and a game function linkage module, and a game content manipulation module, and a game function display module are included in different devices.

FIG. 8 is a diagram for explaining a method of operating a digital item transaction mediation system.

FIG. 9 is a diagram for explaining a method of providing types of digital item transactions.

FIG. 10 is a diagram for explaining a method of providing a detailed list of digital item transaction types.

FIG. 11 is a diagram for explaining a method of randomly selecting a digital item transaction.

FIG. 12 is a diagram for explaining a method of displaying a randomly selected digital item transaction.

FIG. 13 is a diagram for explaining another method of displaying a randomly selected digital item transaction.

FIG. 14 is a diagram for explaining yet another method of displaying a randomly selected digital item transaction.

FIG. 15 is a diagram for explaining a method of displaying an object including information associated with a digital item transaction.

FIG. 16 is a diagram for explaining a method of providing a list of digital item transactions.

FIG. 17 is a diagram for explaining a method of displaying a digital item transaction selected from a list.

FIG. 18 is a diagram for explaining a method of displaying a digital item transaction corresponding to a game function performed according to a result of voting determined by digital item transactions over a predetermined period of time.

FIG. 19 is a diagram for explaining a method of displaying an object associated with a game function performed according to a result of voting determined by digital item transactions over a predetermined period of time.

FIG. 20 is a diagram for explaining a method of integrating a plurality of game functions having the same function.

FIG. 21 is a diagram for explaining a method of integrating a plurality of game functions having the same function from a digital item transaction list.

FIG. 22 is a diagram for explaining a broadcast screen including game content.

FIG. 23 is a diagram for explaining a method of displaying identification information of an executing entity and contents of a game function in an area adjacent to a user character included in game content.

FIG. 24 is a diagram for explaining another method of displaying an object including information associated with a digital item transaction.

FIG. 25 is a diagram for explaining a method of indicating a temporary pause of game content or a streamer terminal.

FIG. 26 is a diagram for explaining a method of adding a game object having a name corresponding to identification information of an executing entity to game content.

FIG. 27 is a diagram for explaining a digital item transaction mediation method.

### DETAILED DESCRIPTION

Hereinafter, specific details for implementing the present disclosure will be described in detail with reference to the accompanying drawings. However, in the following description, detailed explanations of widely known functions or configurations will be omitted if there is a risk of unnecessarily obscuring the gist of the present disclosure.

In the accompanying drawings, the same or corresponding components are assigned the same reference numerals. Furthermore, in the description of the following embodiments, a redundant description of the same or corresponding components may be omitted. However, even if a description of a component is omitted, it is not intended that such a component is not included in any embodiment.

The advantages and features of the disclosed embodiments, and the methods for achieving them, will become clear with reference to the embodiments described later in conjunction with the accompanying drawings. However, the present disclosure is not limited to the embodiments disclosed below but may be implemented in various different forms, and these embodiments are provided merely to make the present disclosure complete and to fully inform a person of ordinary skill in the art of the scope of the invention.

The terms used in this specification will be briefly explained, and the disclosed embodiments will be described in detail. The terms used in this specification have been selected from general terms that are widely used at present, considering the functions in the present disclosure, but the terms may vary depending on the intention of a technician skilled in the relevant field, legal precedent, the emergence of new technology, and so on. Also, in specific cases, there are terms arbitrarily selected by the applicant, and in such cases, their meanings will be described in detail in the corresponding description part of the invention. Therefore, the terms used in the present disclosure should be defined based on the meaning that the terms have and the overall content of the present disclosure, not just the name of the terms.

In this specification, a singular expression includes a plural expression unless it is specifically stated to be singular in the context. Also, a plural expression includes a singular expression unless it is specifically stated to be plural in the context. Throughout the specification, when a part is said to include a certain component, it means that the part may further include other components, rather than excluding other components, unless there is a specific statement to the contrary.

In addition, the term ‘module’ or ‘unit’ as used in the specification means a software or hardware component, and the ‘module’ or ‘unit’ performs certain roles. However, the ‘module’ or ‘unit’ is not limited to software or hardware. A ‘module’ or ‘unit’ may be configured to be in an addressable storage medium and may be configured to reproduce one or more processors. Thus, as an example, a ‘module’ or ‘unit’ may include at least one of components such as software components, object-oriented software components, class components, and task components, and processes, functions, attributes, procedures, subroutines, segments of program code, drivers, firmware, microcode, circuits, data, databases, data structures, tables, arrays, or variables. The function provided within the components and ‘modules’ or ‘units’ may be combined into a smaller number of components and ‘modules’ or ‘units’ or may be further separated into additional components and ‘modules’or ‘units’.

According to an embodiment of the present disclosure, a ‘module’ or ‘unit’ may be implemented as a processor and a memory. A ‘processor’ should be broadly interpreted to include a general-purpose processor, a central processing unit (CPU), a microprocessor, a digital signal processor (DSP), a controller, a microcontroller, a state machine, and so on. In some circumstances, a ‘processor’ may also refer to an application-specific integrated circuit (ASIC), a programmable logic device (PLD), a field-programmable gate array (FPGA), and so on. A ‘processor’ may also refer to a combination of processing devices, such as, for example, a combination of a DSP and a microprocessor, a combination of a plurality of microprocessors, a combination of one or more microprocessors coupled with a DSP core, or any other such configuration. In addition, a ‘memory’ should be broadly interpreted to include any electronic component capable of storing electronic information. A ‘memory’ may also refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage devices, registers, and so on. A memory is said to be in electronic communication with a processor if the processor can read information from and/or write information to the memory. A memory integrated into a processor is in electronic communication with the processor.

In addition, terms such as first, second, A, B, (a), (b), etc. used in the following embodiments are used only to distinguish one component from another, and the essence, order, or sequence of the corresponding component is not limited by those terms.

Furthermore, in the following embodiments, when it is described that a certain component is ‘connected’, ‘coupled’, or ‘attached’ to another component, it should be understood that the component may be directly connected or accessed to the other component, but another component may also be ‘connected’, ‘coupled’, or ‘attached’ between each component.

In addition, ‘comprises’ and/or ‘comprising’ used in the following embodiments do not exclude the presence or addition of one or more other components, steps, operations, and/or elements than the mentioned component, step, operation, and/or element.

Hereinafter, various examples of the present disclosure will be described in detail according to the accompanying drawings.

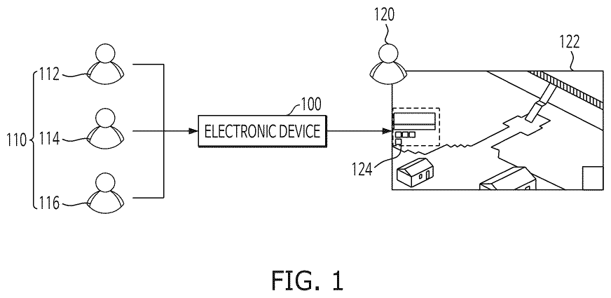

FIG. 1 is a diagram illustratively showing an electronic device for digital item transaction mediation. Referring to FIG. 1, a streamer 120 may conduct a broadcast using a streaming platform. For example, the streamer 120 may transmit a screen 122 including game content through the streaming platform while playing a game. In addition, a viewer 110 (e.g., a first viewer 112, a second viewer 114, or a third viewer 116) may access the corresponding streaming platform to watch the transmitted screen 122, participate in chat, or provide a digital item transaction (e.g., via a sponsorship) to the streamer 120. At this time, an electronic device 100 may mediate the digital item transaction.

An electronic device 100 for mediating digital item transaction may include a communication circuit, a memory, and at least one processor. However, the configuration of the electronic device 100 is not limited to this. According to various examples, the electronic device 100 may further include at least one other component in addition to the above-described components. For example, the electronic device 100 may further include a display for outputting an object associated with a digital item transaction.

A communication circuit (or communication module) may support the establishment of a communication channel between the electronic device 100 and an external electronic device (e.g., a viewer terminal displaying a broadcast screen or a streamer terminal transmitting a broadcast screen) and the performance of wired or wireless communication through the established communication channel. For example, the communication circuit may receive a signal associated with a digital item transaction from the external electronic device and may transmit a signal associated with a game function (or game effect) corresponding to the digital item transaction to the external electronic device.

The memory may store various data used by at least one component (e.g., a processor) of the electronic device 100. The data may, for example, include input data or output data for software (or a program) and instructions associated with the software. The memory may include volatile memory or non-volatile memory.

A processor may be connected to the communication circuit and the memory and may be configured to execute at least one computer-readable program included in the memory. For example, the processor may execute software (or a program) to control at least one other component (e.g., a hardware or software component) of the electronic device 100 connected to the processor, and may perform various data processing or operations. According to an example, as at least part of the data processing or operations, the processor may load a command or data received from another component (e.g., the communication circuit) into a volatile memory, process the command or data stored in the volatile memory, and store the resulting data in a non-volatile memory.

The at least one program executed by the processor may include instructions associated with digital item transaction mediation. Hereinafter, although it is described that the processor performs a certain function, this is for convenience of explanation, and it can be understood that the function performed by the processor is substantially the processor executing instructions included in at least one program stored in the memory.

In relation to digital item transaction mediation, the processor may receive a first signal associated with a digital item transaction from a first external electronic device. Here, the first external electronic device may be an electronic device of a viewer 110 who provides a digital item transaction to a streamer 120, that is, a viewer terminal. For example, the processor may receive a request signal for a digital item transaction that affects the streaming game content from the viewer terminal.

Then, the processor may, in response to receiving the first signal, transmit a second signal associated with a game function corresponding to the digital item transaction to a second external electronic device. Here, the second external electronic device may be an electronic device of the streamer 120 providing the game content, that is, a streamer terminal. Alternatively, the second external electronic device may be a game server providing the game content. For example, the processor may transmit a signal associated with a game function applied to the game content to the streamer terminal or the game server that provides the game content, based on a digital item transaction request received from the viewer 110.

Upon receiving the signal associated with the game function, the second external electronic device may apply the game function to the game content. The game function may exhibit an effect that influences the game progress and may be classified into a positive effect and a negative effect. For example, the game function may include a function of changing at least one attribute (e.g., health, movement speed, field of view, etc.) of a user's character or a game object (e.g., a mob) included in the game content, a function of adding a game item (e.g., a weapon) that the user's character can use to the game content, a function of adding a game object to the game content, and the like. At this time, a game object added to the game content may be created with a name corresponding to the sponsor's identification information. For example, the game function may include a function of adding a game object having a name corresponding to the sponsor's identification information to the game content.

According to an example, the game function may be applied to the game content when a predetermined time has elapsed after receiving the signal associated with the game function. For example, the game function may be applied to the game content with a grace period of a predetermined time after the streamer 120 recognizes the game function to be applied to the game content. In addition, if there is another game function waiting to be applied due to another digital item transaction, the game function may be applied to the game content after the other waiting game function is applied. At this time, the time for the game function to be applied, that is, a predetermined time counted after receiving the signal associated with the game function, may start counting after the other waiting game is applied. For example, the game function may be applied to the game content when a predetermined time has elapsed after the other waiting game is applied.

According to an example, the game function may be sequentially applied to the game content along with other game functions waiting to be applied. For this purpose, a signal for applying the game function may be stored and managed in a queue-type data structure. In addition, at least one game function to be applied to the game content may be added to a list and managed.

According to an example, information associated with the digital item transaction may be exposed (e.g., displayed) on a broadcast screen, that is, a screen 122 including the game content, until the game function corresponding to the digital item transaction is applied to the game content. For example, an object 124 including information associated with the digital item transaction may be displayed overlapping at least a partial area of the screen 122 including the game content. Here, the information associated with the digital item transaction may include at least one of identification information of the sponsor, contents of the game function corresponding to the digital item transaction, or a time until the game function corresponding to the digital item transaction is applied (e.g., remaining time). At this time, the time until the game function is applied may be counted in a way that the remaining time decreases, like a timer, and may be displayed in at least one of a clock format or a progress bar format. In addition, the object 124 including the information associated with the digital item transaction may be an object that is included only in the broadcast screen and not in the game screen, similar to an object associated with the progress of the broadcast, for example, a real-time shooting screen of a broadcast camera, a broadcast character image of the streamer 120, chat content, etc. For example, the object 124 including the information associated with the digital item transaction may be a broadcast widget displayed in a widget format on the broadcast screen.

According to an example, when the game function corresponding to the digital item transaction is applied to the game content, the identification information of the sponsor and the contents of the game function corresponding to the digital item transaction may be displayed in an area adjacent to the user's character included in the game content.

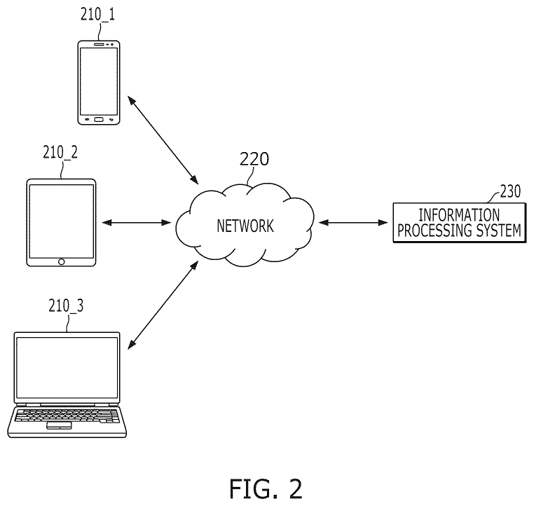

FIG. 2 is a schematic diagram illustrating a configuration in which an information processing system 230 is communicably connected with a plurality of user terminals 210_1, 210_2, 210_3, in relation to data processing according to an example of the present disclosure. The information processing system 230 may include system(s) capable of providing a data processing service (for example, a digital item transaction mediation service). In an example, the information processing system 230 may include one or more server devices and/or databases, or one or more distributed computing devices and/or distributed databases based on a cloud computing service, which can store, provide, and execute computer-executable programs (for example, a downloadable application) and data related to the data processing service. For example, the information processing system 230 may include separate systems (for example, servers) for the data processing service.

A data processing service, etc., provided by the information processing system 230 may be provided to a user/users through a data processing application, a web browser application, etc., installed in each of a plurality of user terminals 210_1, 210_2, 210_3.

The plurality of user terminals 210_1, 210_2, 210_3 may communicate with the information processing system 230 through a network 220. The network 220 may be configured to enable communication between the plurality of user terminals 210_1, 210_2, 210_3 and the information processing system 230. Depending on the installation environment, the network 220 may be configured with, for example, a wired network such as Ethernet, Power Line Communication, a telephone line communication device, and RS-serial communication, a wireless network such as a mobile communication network, Wireless LAN (WLAN), Wi-Fi, Bluetooth, and ZigBee, or a combination thereof. The communication method is not limited, and may include not only communication methods utilizing a communication network that the network 220 can include (for example, a mobile communication network, wired internet, wireless internet, a broadcasting network, a satellite network, etc.), but also short-range wireless communication between the user terminals 210_1, 210_2, 210_3.

For example, the plurality of user terminals 210_1, 210_2, 210_3 may transmit a data processing request and an instruction associated with a user request for data processing to the information processing system 230 through the network 220, and the information processing system 230 may receive the data processing request and the instruction.

In FIG. 2, a mobile phone terminal 210_1, a tablet terminal 210_2, and a PC terminal 210_3 are shown as examples of user terminals, but the present disclosure is not limited to these, and the user terminals 210_1, 210_2, 210_3 may be any computing device capable of wired and/or wireless communication and on which a data processing application, etc., can be installed and executed. For example, a user terminal may include a smartphone, a mobile phone, a navigation device, a computer, a laptop, a terminal for digital broadcasting, a Personal Digital Assistant (PDA), a Portable Multimedia Player (PMP), a tablet PC, a game console, a wearable device, an internet of things (IoT) device, a virtual reality (VR) device, an augmented reality (AR) device, and the like. In addition, although FIG. 2 shows three user terminals 210_1, 210_2, 210_3 communicating with the information processing system 230 through the network 220, the present disclosure is not limited to this, and a different number of user terminals may be configured to communicate with the information processing system 230 through the network 220.

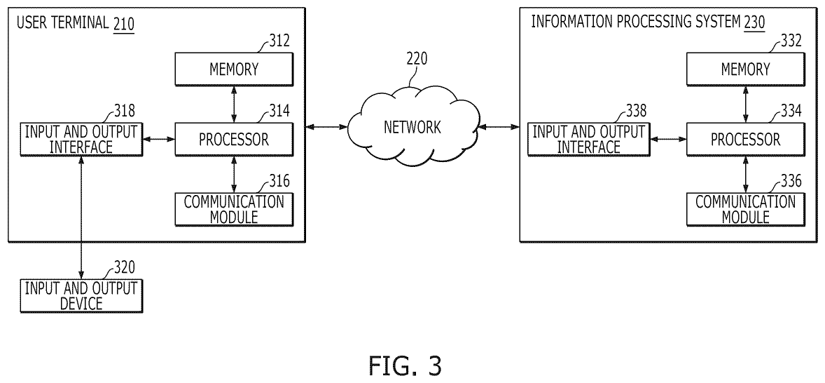

FIG. 3 is a block diagram illustrating the internal configuration of a user terminal 210 and an information processing system 230 according to an example of the present disclosure. The user terminal 210 may refer to any computing device on which a data processing application, etc., can be executed and which is capable of wired/wireless communication, and may include, for example, the mobile phone terminal 210_1, the tablet terminal 210_2, the PC terminal 210_3, etc., of FIG. 2. As shown, the user terminal 210 may include a memory 312, a processor 314, a communication module 316, and an input/output interface 318. Similarly, the information processing system 230 may include a memory 332, a processor 334, a communication module 336, and an input/output interface 338. As shown in FIG. 3, the user terminal 210 and the information processing system 230 may be configured to communicate information and/or data through a network 220 using their respective communication modules 316, 336. In addition, an input/output device 320 may be configured to input information and/or data to the user terminal 210 through the input/output interface 318 or to output information and/or data generated from the user terminal 210.

The memories 312, 332 may include any non-transitory computer-readable recording medium. According to an example, the memories 312, 332 may include a permanent mass storage device such as a read-only memory (ROM), a disk drive, a solid-state drive (SSD), a flash memory, and the like. As another example, a non-volatile mass storage device such as a ROM, SSD, flash memory, disk drive, etc., may be included in the user terminal 210 or the information processing system 230 as a separate permanent storage device distinct from the memory. In addition, an operating system and at least one program code (e.g., code for an application associated with a data processing service, etc.) may be stored in the memories 312, 332.

These software components may be loaded from a computer-readable recording medium separate from the memories 312, 332. Such a separate computer-readable recording medium may include a recording medium that can be directly connected to the user terminal 210 and the information processing system 230, for example, it may include a computer-readable recording medium such as a floppy drive, a disk, a tape, a DVD/CD-ROM drive, a memory card, and the like. As another example, the software components may be loaded into the memories 312, 332 through the communication modules 316, 336, not a computer-readable recording medium. For example, at least one program may be loaded into the memories 312, 332 based on a computer program (e.g., an application associated with a data processing service, etc.) installed by files provided through the network 220 by developers or a file distribution system that distributes installation files of an application.

The processors 314, 334 may be configured to process instructions of a computer program by performing basic arithmetic, logic, and input/output operations. Instructions may be provided to the processors 314, 334 by the memories 312, 332 or the communication modules 316, 336. For example, the processors 314, 334 may be configured to execute received instructions according to program code stored in a recording device such as the memories 312, 332.

The communication modules 316, 336 may provide a configuration or function for the user terminal 210 and the information processing system 230 to communicate with each other through the network 220, and may provide a configuration or function for the user terminal 210 and/or the information processing system 230 to communicate with another user terminal or another system (for example, a separate cloud system, etc.). For example, a request or data (e.g., a data processing request or data, etc.) generated by the processor 314 of the user terminal 210 according to program code stored in a recording device such as the memory 312 may be transmitted to the information processing system 230 through the network 220 under the control of the communication module 316. Conversely, a control signal or command provided under the control of the processor 334 of the information processing system 230 may be received by the user terminal 210 through the communication module 336 of the user terminal 210 via the network 220 and the communication module 336.

The input/output interface 318 may be a means for interfacing with the input/output device 320. As an example, the input device may include devices such as a camera including an audio sensor and/or an image sensor, a keyboard, a microphone, a mouse, and the output device may include devices such as a display, a speaker, a haptic feedback device, and the like. As another example, the input/output interface 318 may be a means for interfacing with a device in which a configuration or function for performing input and output is integrated into one, such as a touchscreen. Although FIG. 3 shows the input/output device 320 as not being included in the user terminal 210, the present disclosure is not limited to this, and the input/output device 320 may be configured as a single device with the user terminal 210. In addition, the input/output interface 338 of the information processing system 230 may be a means for interfacing with a device (not shown) for input or output that is connected to the information processing system 230 or that the information processing system 230 may include. Although FIG. 3 shows the input/output interfaces 318, 338 as elements configured separately from the processors 314, 334, the present disclosure is not limited to this, and the input/output interfaces 318, 338 may be configured to be included in the processors 314, 334.

The user terminal 210 and the information processing system 230 may include more components than the components of FIG. 3. However, it is not necessary to clearly show most conventional technical components. In an example, the user terminal 210 may be implemented to include at least some of the above-described input/output devices 320. In addition, the user terminal 210 may further include other components such as a transceiver, a Global Positioning System (GPS) module, a camera, various sensors, a database, and the like. For example, if the user terminal 210 is a smartphone, the user terminal 210 may include components that a smartphone generally includes, and for example, various components such as an acceleration sensor, a gyro sensor, a microphone module, a camera module, various physical buttons, buttons using a touch panel, input/output ports, a vibrator for vibration, and the like may be implemented to be further included in the user terminal 210.

According to an example, the processor 314 of the user terminal 210 may be configured to operate a data processing application or a web browser application that provides a data processing service. At this time, program code associated with the corresponding application may be loaded into the memory 312 of the user terminal 210. While the application is operating, the processor 314 of the user terminal 210 may receive information and/or data provided from the input/output device 320 through the input/output interface 318 or receive information and/or data from the information processing system 230 through the communication module 316, and may process the received information and/or data and store the processed information and/or data in the memory 312. In addition, such information and/or data may be provided to the information processing system 230 through the communication module 316.

While the data processing application is operating, the processor 314 may receive voice data, text, an image, a video, etc., input or selected through an input device such as a touch screen, a keyboard, an audio sensor, a camera including an image sensor, or a microphone connected to the input/output interface 318, and may store the received voice data, text, image, and/or video in the memory 312 or provide the received voice data, text, image, and/or video to the information processing system 230 through the communication module 316 and the network 220. In an example, the processor 314 may receive a user input input through the input device, and may provide data/a request corresponding to the received user input to the information processing system 230 through the network 220 and the communication module 316.

The processor 314 of the user terminal 210 may transmit information and/or data to the input/output device 320 through the input/output interface 318 to output the information and/or data. For example, the processor 314 of the user terminal 210 may output processed information and/or data through an output device 320 such as a display-capable device (e.g., a touch screen, a display, etc.), a voice-output-capable device (e.g., a speaker), and the like.

The processor 334 of the information processing system 230 may be configured to manage, process, and/or store information and/or data received from the plurality of user terminals 210 and/or a plurality of external systems. Information and/or data processed by the processor 334 may be provided to the user terminal 210 through the communication module 336 and the network 220.

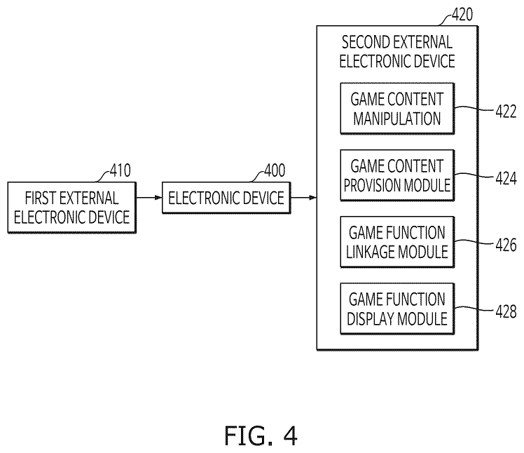

FIG. 4 is a diagram for explaining a digital item transaction mediation system in which a game content manipulation module, a game content provision module, a game function linkage module, and a game function display module are included in one device according to an example of the present disclosure. Referring to FIG. 4, a digital item transaction mediation system may include an electronic device 400 (e.g., the electronic device 100 of FIG. 1), a first external electronic device 410, and a second external electronic device 420. Here, the electronic device 400 may be a digital item transaction mediation server, the first external electronic device 410 may be a viewer terminal, and the second external electronic device 420 may be a streamer terminal. FIG. 4 will explain a digital item transaction mediation system in which a game content manipulation module 422, a game content provision module 424, a game function linkage module 426, and a game function display module 428 are all included in the second external electronic device 420. Here, the game content manipulation module 422 may receive a user input for manipulating a game and may reflect the user input in game content by transmitting the received user input to the game content provision module 424. In addition, the game content provision module 424 may provide game content and may reflect the user input in the game content. In addition, the game function linkage module 426 may reflect a game function corresponding to a digital item transaction in the game content. In addition, the game function display module 428 may display an object including information associated with the digital item transaction on a screen including the game content, that is, a broadcast screen.

First, the first external electronic device 410 may provide an interface that supports a viewer to provide a digital item transaction to a streamer. For example, the first external electronic device 410 may display a list of digital item transactions that affect game content and may receive a user input that selects one of the digital item transactions included in the list. In addition, the first external electronic device 410 may, in response to receiving the user input, transmit a signal associated with the selected digital item transaction to the electronic device 400.

The electronic device 400 that has received the signal associated with the digital item transaction from the first external electronic device 410 may acquire information associated with the digital item transaction based on the received signal. Here, the information associated with the digital item transaction may include at least one of identification information of a sponsor, contents of a game function corresponding to the digital item transaction, or a time until the game function corresponding to the digital item transaction is applied (e.g., remaining time). In addition, the electronic device 400 may transmit a signal associated with the game function corresponding to the digital item transaction to the second external electronic device 420 based on the information associated with the digital item transaction.

The second external electronic device 420 that has received the signal associated with the game function corresponding to the digital item transaction from the electronic device 400 may, through the game function linkage module 426, apply the game function to the game content. Here, the game function may include a function of changing at least one attribute (e.g., health, movement speed, field of view, etc.) of a user's character or a game object (e.g., a mob) included in the game content, a function of adding a game item (e.g., a weapon) that the user's character can use to the game content, a function of adding a game object to the game content, and the like. Then, the second external electronic device 420 may, through the game content provision module 424, provide the game content to which the game function is applied. For example, the second external electronic device 420 may display a screen including the game content to which the game function is applied through a display.

According to an example, the second external electronic device 420 may apply the game function to the game content through the game function linkage module 426 when a predetermined time has elapsed after receiving the signal associated with the game function. In addition, if there is another game function waiting to be applied due to another digital item transaction, the second external electronic device 420 may apply the game function to the game content after the other waiting game function is applied. For example, the second external electronic device 420 may apply the game function to the game content when a predetermined time has elapsed after the other waiting game is applied. In other words, the second external electronic device 420 may sequentially apply the game function to the game content along with other game functions waiting to be applied. For example, the second external electronic device 420 may store and manage a signal for applying the game function in a queue-type data structure and may add and manage at least one game function to be applied to the game content in a list.

According to an example, the second external electronic device 420 may, through the game function display module 428, display an object including information associated with the digital item transaction overlapping at least a part of the screen including the game content. For example, the second external electronic device 420 may display the object including the information associated with the digital item transaction on the broadcast screen, similar to an object associated with the progress of the broadcast (e.g., a real-time shooting screen of a broadcast camera, a streamer's broadcast character image, chat content, etc.). For example, the second external electronic device 420 may display the object including the information associated with the digital item transaction in a widget format on the broadcast screen.

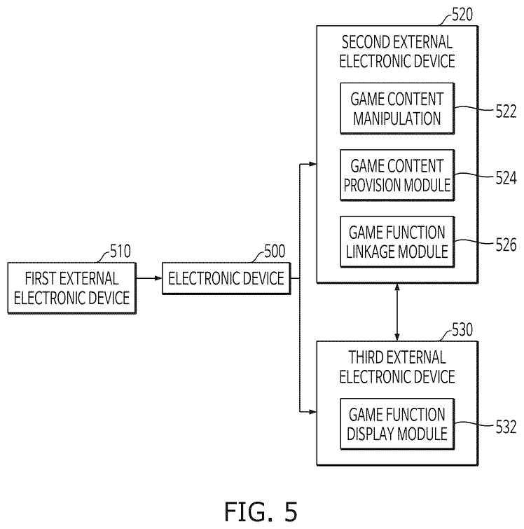

FIG. 5 is a diagram for explaining a digital item transaction mediation system in which a game content manipulation module, a game content provision module, and a game function linkage module, and a game function display module are included in different devices according to an example of the present disclosure. Referring to FIG. 5, a digital item transaction mediation system may include an electronic device 500 (e.g., the electronic device 100 of FIG. 1), a first external electronic device 510, a second external electronic device 520, and a third external electronic device 530. Here, the electronic device 500 may be a digital item transaction mediation server, the first external electronic device 510 may be a viewer terminal, the second external electronic device 520 may be a first streamer terminal, and the third external electronic device 530 may be a second streamer terminal connected to the first streamer terminal. FIG. 5 will explain a digital item transaction mediation system in which a game content manipulation module 522, a game content provision module 524, and a game function linkage module 526 are included in the second external electronic device 520, and a game function display module 532 is included in the third external electronic device 530.

First, the first external electronic device 510 may provide an interface that supports a viewer to provide a digital item transaction to a streamer. For example, the first external electronic device 510 may display a list of digital item transactions that affect game content and may receive a user input that selects one of the digital item transactions included in the list. In addition, the first external electronic device 510 may, in response to receiving the user input, transmit a signal associated with the selected digital item transaction to the electronic device 500.

The electronic device 500 that has received the signal associated with the digital item transaction from the first external electronic device 510 may acquire information associated with the digital item transaction based on the received signal. Here, the information associated with the digital item transaction may include at least one of identification information of a sponsor, contents of a game function corresponding to the digital item transaction, or a time until the game function corresponding to the digital item transaction is applied (e.g., remaining time). In addition, the electronic device 500 may transmit a signal associated with the game function corresponding to the digital item transaction to the second external electronic device 520 based on the information associated with the digital item transaction. In addition, the electronic device 500 may transmit a signal associated with an application of the game function corresponding to the digital item transaction to the third external electronic device 530 connected to the second external electronic device 520.

The second external electronic device 520 that has received the signal associated with the game function corresponding to the digital item transaction from the electronic device 500 may, through the game function linkage module 526, apply the game function to the game content. Here, the game function may include a function of changing at least one attribute (e.g., health, movement speed, field of view, etc.) of a user's character or a game object (e.g., a mob) included in the game content, a function of adding a game item (e.g., a weapon) that the user's character can use to the game content, a function of adding a game object to the game content, and the like. Then, the second external electronic device 520 may, through the game content provision module 524, provide the game content to which the game function is applied. For example, the second external electronic device 520 may display a screen including the game content to which the game function is applied through a display.

According to an example, the second external electronic device 520 may apply the game function to the game content through the game function linkage module 526 when a predetermined time has elapsed after receiving the signal associated with the game function. In addition, if there is another game function waiting to be applied due to another digital item transaction, the second external electronic device 520 may apply the game function to the game content after the other waiting game function is applied. For example, the second external electronic device 520 may apply the game function to the game content when a predetermined time has elapsed after the other waiting game is applied. In other words, the second external electronic device 520 may sequentially apply the game function to the game content along with other game functions waiting to be applied. For example, the second external electronic device 520 may store and manage a signal for applying the game function in a queue-type data structure and may add and manage at least one game function to be applied to the game content in a list.

The third external electronic device 530 that has received the signal associated with the application of the game function corresponding to the digital item transaction from the electronic device 500 may, through the game function display module 532, display an object including information associated with the digital item transaction overlapping at least a part of the screen including the game content. For example, the third external electronic device 530 may display the object including the information associated with the digital item transaction on the broadcast screen, similar to an object associated with the progress of the broadcast (e.g., a real-time shooting screen of a broadcast camera, a streamer's broadcast character image, chat content, etc.). For example, the third external electronic device 530 may display the object including the information associated with the digital item transaction in a widget format on the broadcast screen.

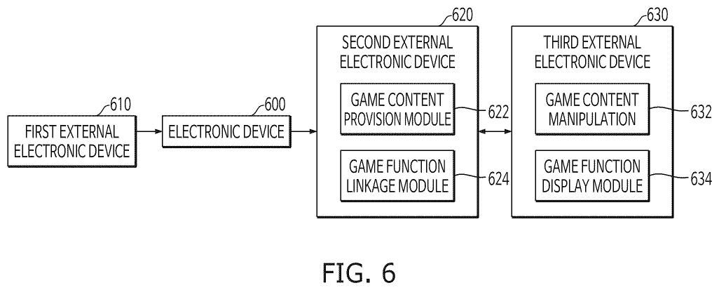

FIG. 6 is a diagram for explaining a digital item transaction mediation system in which a game content provision module and a game function linkage module, and a game content manipulation module and a game function display module are included in different devices according to an example of the present disclosure. Referring to FIG. 6, a digital item transaction mediation system may include an electronic device 600 (e.g., the electronic device 100 of FIG. 1), a first external electronic device 610, a second external electronic device 620, and a third external electronic device 630. Here, the electronic device 600 may be a digital item transaction mediation server, the first external electronic device 610 may be a viewer terminal, the second external electronic device 620 may be a game server, and the third external electronic device 630 may be a streamer terminal. FIG. 6 will explain a digital item transaction mediation system in which a game content provision module 622 and a game function linkage module 624 are included in the second external electronic device 620, and a game content manipulation module 632 and a game function display module 634 are included in the third external electronic device 630.

First, the first external electronic device 610 may provide an interface that supports a viewer to provide a digital item transaction to a streamer. For example, the first external electronic device 610 may display a list of digital item transactions that affect game content and may receive a user input that selects one of the digital item transactions included in the list. In addition, the first external electronic device 610 may, in response to receiving the user input, transmit a signal associated with the selected digital item transaction to the electronic device 600.

The electronic device 600 that has received the signal associated with the digital item transaction from the first external electronic device 610 may acquire information associated with the digital item transaction based on the received signal. Here, the information associated with the digital item transaction may include at least one of identification information of a sponsor, contents of a game function corresponding to the digital item transaction, or a time until the game function corresponding to the digital item transaction is applied (e.g., remaining time). In addition, the electronic device 600 may transmit a signal associated with the game function corresponding to the digital item transaction to the second external electronic device 620 based on the information associated with the digital item transaction.

The second external electronic device 620 that has received the signal associated with the game function corresponding to the digital item transaction from the electronic device 600 may, through the game function linkage module 624, apply the game function to the game content. Here, the game function may include a function of changing at least one attribute (e.g., health, movement speed, field of view, etc.) of a user's character or a game object (e.g., a mob) included in the game content, a function of adding a game item (e.g., a weapon) that the user's character can use to the game content, a function of adding a game object to the game content, and the like. Then, the second external electronic device 620 may, through the game content provision module 622, provide the game content to which the game function is applied. For example, the second external electronic device 620 may transmit the game content to which the game function is applied to the third external electronic device 630.

According to an example, the second external electronic device 620 may apply the game function to the game content through the game function linkage module 624 when a predetermined time has elapsed after receiving the signal associated with the game function. For example, the second external electronic device 620 may transmit the game content before the game function is applied to the third external electronic device 630, and then, when the signal associated with the game function is received and a predetermined time has elapsed, the second external electronic device 620 may transmit the game content to which the game function is applied to the third external electronic device 630. In addition, if there is another game function waiting to be applied due to another digital item transaction, the second external electronic device 620 may apply the game function to the game content after the other waiting game function is applied. For example, the second external electronic device 620 may apply the game function to the game content when a predetermined time has elapsed after the other waiting game is applied. In other words, the second external electronic device 620 may sequentially apply the game function to the game content along with other game functions waiting to be applied. For example, the second external electronic device 620 may store and manage a signal for applying the game function in a queue-type data structure and may add and manage at least one game function to be applied to the game content in a list.

The third external electronic device 630 that has received the game content from the second external electronic device 620 may display a screen including the game content through a display. In addition, the third external electronic device 630 may, through the game content manipulation module 632, receive a user input during game play and transmit the received user input to the second external electronic device 620 so that the user input is reflected in the game content.

According to an example, the second external electronic device 620 may transmit a signal associated with an application of the game function corresponding to the digital item transaction to the third external electronic device 630. In some examples, the electronic device 600 may transmit a signal associated with the application of the game function corresponding to the digital item transaction to the third external electronic device 630.

The third external electronic device 630 that has received the signal associated with the application of the game function corresponding to the digital item transaction from the electronic device 600 or the second external electronic device 620 may, through the game function display module 634, display an object including information associated with the digital item transaction overlapping at least a part of the screen including the game content. For example, the third external electronic device 630 may display the object including the information associated with the digital item transaction on the broadcast screen, similar to an object associated with the progress of the broadcast (e.g., a real-time shooting screen of a broadcast camera, a streamer's broadcast character image, chat content, etc.). For example, the third external electronic device 630 may display the object including the information associated with the digital item transaction in a widget format on the broadcast screen.

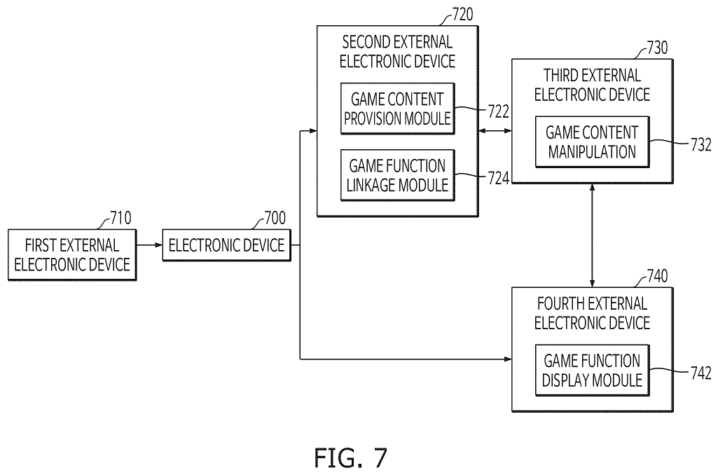

FIG. 7 is a diagram for explaining a digital item transaction mediation system in which a game content provision module and a game function linkage module, and a game content manipulation module, and a game function display module are included in different devices according to an example of the present disclosure. Referring to FIG. 7, a digital item transaction mediation system may include an electronic device 700 (e.g., the electronic device 100 of FIG. 1), a first external electronic device 710, a second external electronic device 720, a third external electronic device 730, and a fourth external electronic device 740. Here, the electronic device 700 may be a digital item transaction mediation server, the first external electronic device 710 may be a viewer terminal, the second external electronic device 720 may be a game server, the third external electronic device 730 may be a first streamer terminal, and the fourth external electronic device 740 may be a second streamer terminal connected to the first streamer terminal. FIG. 7 will explain a digital item transaction mediation system in which a game content provision module 722 and a game function linkage module 724 are included in the second external electronic device 720, a game content manipulation module 732 is included in the third external electronic device 730, and a game function display module 742 is included in the fourth external electronic device 740.

First, the first external electronic device 710 may provide an interface that supports a viewer to provide a digital item transaction to a streamer. For example, the first external electronic device 710 may display a list of digital item transactions that affect game content and may receive a user input that selects one of the digital item transactions included in the list. In addition, the first external electronic device 710 may, in response to receiving the user input, transmit a signal associated with the selected digital item transaction to the electronic device 700.

The electronic device 700 that has received the signal associated with the digital item transaction from the first external electronic device 710 may acquire information associated with the digital item transaction based on the received signal. Here, the information associated with the digital item transaction may include at least one of identification information of a sponsor, contents of a game function corresponding to the digital item transaction, or a time until the game function corresponding to the digital item transaction is applied (e.g., remaining time). In addition, the electronic device 700 may transmit a signal associated with the game function corresponding to the digital item transaction to the second external electronic device 720 based on the information associated with the digital item transaction.

The second external electronic device 720 that has received the signal associated with the game function corresponding to the digital item transaction from the electronic device 700 may, through the game function linkage module 724, apply the game function to the game content. Here, the game function may include a function of changing at least one attribute (e.g., health, movement speed, field of view, etc.) of a user's character or a game object (e.g., a mob) included in the game content, a function of adding a game item (e.g., a weapon) that the user's character can use to the game content, a function of adding a game object to the game content, and the like. Then, the second external electronic device 720 may, through the game content provision module 722, provide the game content to which the game function is applied. For example, the second external electronic device 720 may transmit the game content to which the game function is applied to the third external electronic device 730.

According to an example, the second external electronic device 720 may apply the game function to the game content through the game function linkage module 724 when a predetermined time has elapsed after receiving the signal associated with the game function. For example, the second external electronic device 720 may transmit the game content before the game function is applied to the third external electronic device 730, and then, when the signal associated with the game function is received and a predetermined time has elapsed, the second external electronic device 720 may transmit the game content to which the game function is applied to the third external electronic device 730. In addition, if there is another game function waiting to be applied due to another digital item transaction, the second external electronic device 720 may apply the game function to the game content after the other waiting game function is applied. For example, the second external electronic device 720 may apply the game function to the game content when a predetermined time has elapsed after the other waiting game is applied. In other words, the second external electronic device 720 may sequentially apply the game function to the game content along with other game functions waiting to be applied. For example, the second external electronic device 720 may store and manage a signal for applying the game function in a queue-type data structure and may add and manage at least one game function to be applied to the game content in a list.

The third external electronic device 730 that has received the game content from the second external electronic device 720 may display a screen including the game content through a display. In addition, the third external electronic device 730 may, through the game content manipulation module 732, receive a user input during game play and transmit the received user input to the second external electronic device 720 so that the user input is reflected in the game content.

According to an example, the second external electronic device 720 may transmit a signal associated with an application of the game function corresponding to the digital item transaction to a fourth external electronic device 740 connected to the third external electronic device 730. In some examples, the electronic device 700 may transmit a signal associated with the application of the game function corresponding to the digital item transaction to the fourth external electronic device 740 connected to the third external electronic device 730.

The fourth external electronic device 740 that has received the signal associated with the application of the game function corresponding to the digital item transaction from the electronic device 700 or the second external electronic device 720 may, through the game function display module 742, display an object including information associated with the digital item transaction overlapping at least a part of the screen including the game content. For example, the fourth external electronic device 740 may display the object including the information associated with the digital item transaction on the broadcast screen, similar to an object associated with the progress of the broadcast (e.g., a real-time shooting screen of a broadcast camera, a streamer's broadcast character image, chat content, etc.). For example, the fourth external electronic device 740 may display the object including the information associated with the digital item transaction in a widget format on the broadcast screen.

In FIGS. 4 and 5 described above, the game content manipulation modules 422, 522 and the game content provision modules 424, 524 are included in a streamer terminal, so that the entire content of the game is installed on the streamer terminal, and the game can operate independently on the streamer terminal without linked operation with a game server. In addition, in FIGS. 6 and 7 described above, the game content manipulation modules 632, 732 are included in a streamer terminal, and the game content provision modules 622, 722 are included in a game server, so that at least some content of the game is installed on the streamer terminal, and the game can operate on the streamer terminal through linked operation with the game server. At this time, the game may include a plugin game in which a game function corresponding to a digital item transaction can be applied during the operation of the game. A plugin game may refer to a game to which a software module (e.g., a game function) developed by a user or a third party can be added to the game content created by a game producer.

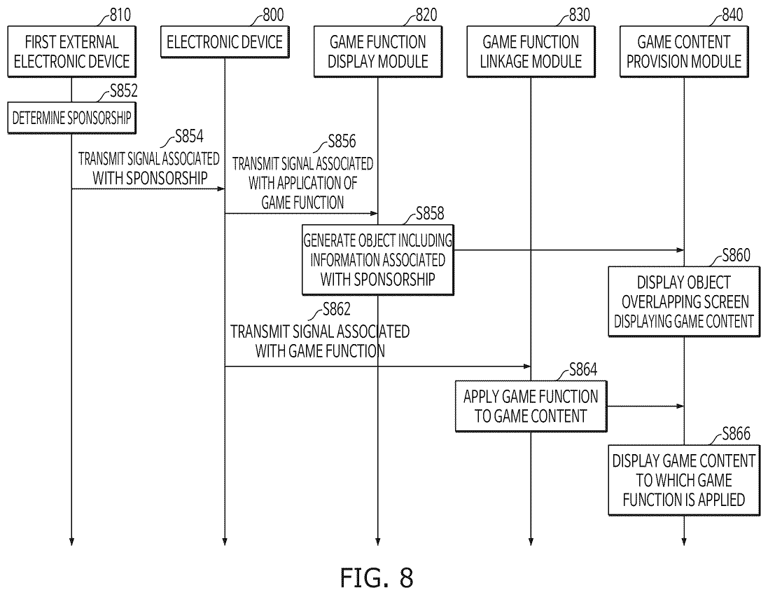

FIG. 8 is a diagram for explaining a method of operating a digital item transaction mediation system according to an example of the present disclosure. Referring to FIG. 8, a first external electronic device 810 may determine a digital item transaction in step S852. For example, the first external electronic device 810 may display a list of digital item transactions that affect game content and may receive a user input that selects one of the digital item transactions included in the list. Then, in step S854, the first external electronic device 810 may transmit a signal associated with the digital item transaction to an electronic device 800.

The electronic device 800 that has received the signal associated with the digital item transaction from the first external electronic device 810 may acquire information associated with the digital item transaction based on the received signal. Then, in step S856, the electronic device 800 may transmit a signal associated with an application of a game function corresponding to the digital item transaction to a game function display module 820.

The game function display module 820 that has received the signal associated with the application of the game function corresponding to the digital item transaction from the electronic device 800 may, in step S858, generate an object including information associated with the digital item transaction. Then, the game function display module 820 may transmit the object including the information associated with the digital item transaction to a game content provision module 840, and the game content provision module 840 may, in step S860, display the object including the information associated with the digital item transaction overlapping a screen displaying the game content. For example, the game content provision module 840 may display the object including the information associated with the digital item transaction in a widget format on a broadcast screen.

In step S862, the electronic device 800 may transmit a signal associated with the game function corresponding to the digital item transaction to a game function linkage module 830. The game function linkage module 830 that has received the signal associated with the game function corresponding to the digital item transaction from the electronic device 800 may, in step S864, apply the game function to the game content. For example, the game function linkage module 830 may change at least one attribute (e.g., health, movement speed, field of view, etc.) of a user's character or a game object (e.g., a mob) included in the game content, or add a game item (e.g., a weapon) that the user's character can use to the game content, or add a game object to the game content. Then, in step S866, the game content provision module 840 may display the game content to which the game function is applied. For example, the game content provision module 840 may display a screen including the game content to which the game function is applied through a display.

According to an example, step S862 may be performed before step S856. Alternatively, step S856 and step S862 may be performed simultaneously. However, regardless of the order of performance of step S856 and step S862, step S866 may be performed after step S860 is performed.

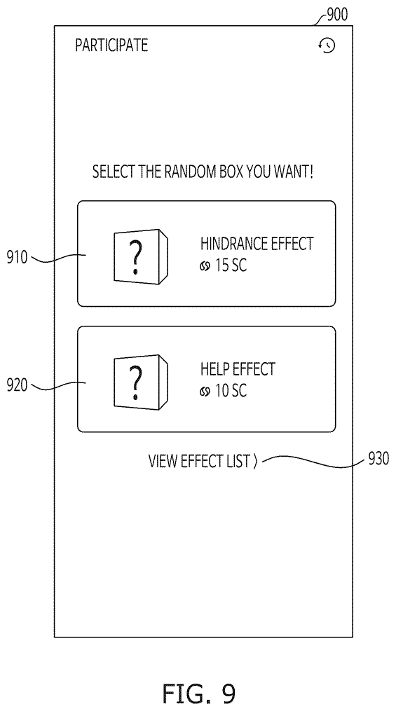

FIG. 9 is a diagram for explaining a method of providing types of digital item transaction according to an example of the present disclosure. Referring to FIG. 9, a viewer terminal may provide an interface 900 that supports a viewer to provide a digital item transaction to a streamer. The interface 900 may display a list of digital item transactions that affect game content. Alternatively, the interface 900 may support the viewer to randomly select a digital item transaction. At this time, the interface 900 may classify and provide the types of digital item transaction according to what kind of influence a game function corresponding to the digital item transaction can have on the game progress. For example, a game function may exhibit an effect that influences the game progress and may be classified into a positive effect (or help effect) and a negative effect (or hindrance effect). According to an example, at least one of a game function corresponding to a digital item transaction or a type of digital item transaction may be classified by a streamer, and the streamer may add, change, or delete such a classification. In addition, content about the classification of at least one of the game function or the type of digital item transaction by the streamer and the addition, change, or deletion of the classification may be reflected in the interface 900 and exposed to the viewer.

The interface 900 may include a first object 910 that allows for random selection of a game function that can have a negative effect (or hindrance effect) on the game, a second object 920 that allows for random selection of a game function that can have a positive effect (or help effect) on the game, and a third object 930 for providing a detailed list of digital item transaction types.

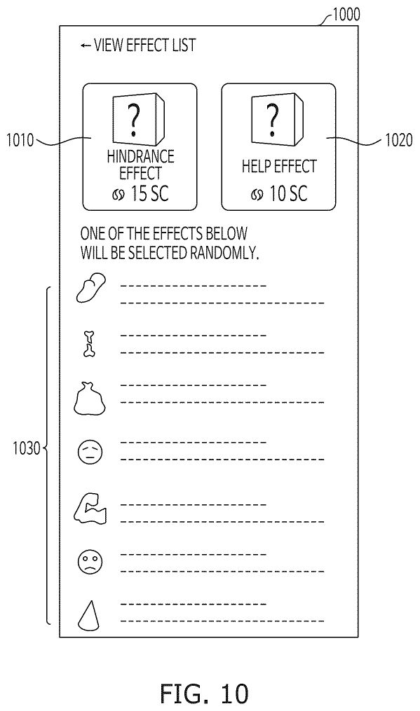

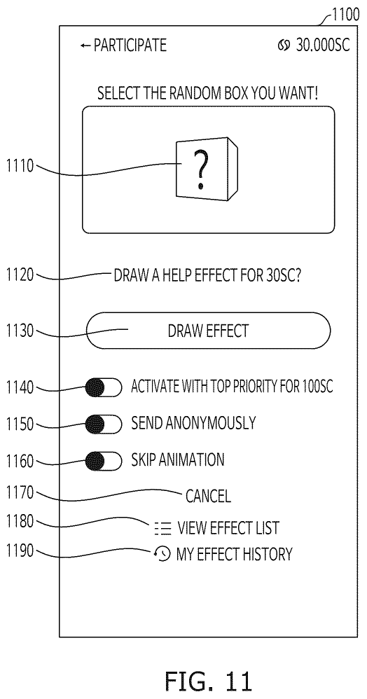

If the first object 910 or the second object 920 is selected, as shown in FIG. 11, the interface 900 may support the random selection of a game function that can have the selected positive effect (or help effect) or negative effect (or hindrance effect). In addition, if the third object 930 is selected, as shown in FIG. 10, the interface 900 may support the provision of a detailed list of digital item transaction types.

FIG. 10 is a diagram for explaining a method of providing a detailed list of digital item transaction types according to an example of the present disclosure. Referring to FIG. 10, a viewer terminal may provide an interface 1000 that supports a viewer to provide a digital item transaction to a streamer. The interface 1000 may classify and provide the types of digital item transaction according to what kind of influence a game function corresponding to the digital item transaction can have on the game progress. For example, the interface 1000 may include a first object 1010 that allows for random selection of a game function that can have a negative effect (or hindrance effect) on the game, a second object 1020 that allows for random selection of a game function that can have a positive effect (or help effect) on the game, and a detailed list 1030 of digital item transaction types.

The detailed list 1030 of digital item transaction types may be changed according to the selection of the first object 1010 or the second object 1020. For example, if the first object 1010 is selected, the detailed list 1030 of digital item transaction types may display game functions that can have a negative effect (or hindrance effect) on the game as items, and if the second object 1020 is selected, the detailed list 1030 of digital item transaction types may display game functions that can have a positive effect (or help effect) on the game as items. At this time, each of the game functions displayed as items may include information about identification information of the game function, contents of the game function, and a probability of being randomly drawn.

FIG. 11 is a diagram for explaining a method of randomly selecting a digital item transaction according to an example of the present disclosure. Referring to FIG. 11, a viewer terminal may provide an interface 1100 that supports a viewer to provide a digital item transaction to a streamer. The interface 1100 may support the viewer to randomly select a digital item transaction. At this time, the interface 1100 may classify and provide the types of digital item transaction according to what kind of influence a game function corresponding to the digital item transaction can have on the game progress, and may support the random selection of a game function that can have the selected positive effect (or help effect) or negative effect (or hindrance effect).

The interface 1100 may include an image 1110 (e.g., a random box image) indicating whether the selected game function is a game function of a positive effect (or help effect) or a game function of a negative effect (or hindrance effect), information 1120 about a digital item transaction amount of a random game function, a selection button 1130 for a random game function (e.g., a button for selecting a random draw), a button 1140 for selecting whether to preferentially apply the randomly selected game function, a button 1150 for selecting whether to make a sponsor's identification information anonymous when sponsoring, a button 1160 for selecting whether to skip an animation shown during random selection of a game function, a cancel button 1170, a button 1180 for providing a detailed list of digital item transaction types, and a button 1190 for providing a history of game functions sponsored by a user.

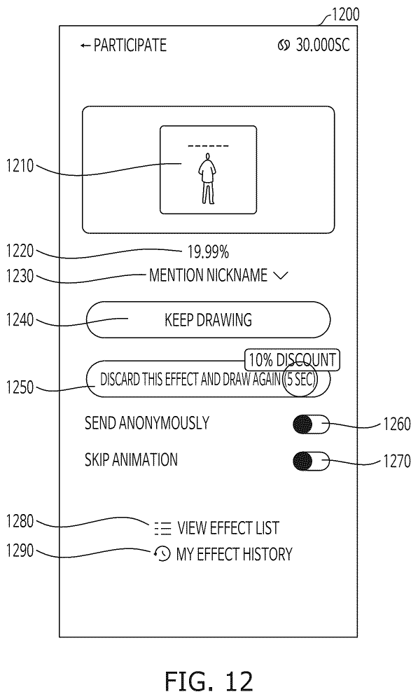

FIG. 12 is a diagram for explaining a method of displaying a randomly selected digital item transaction according to an example of the present disclosure. Referring to FIG. 12, a viewer terminal may provide an interface 1200 that supports a viewer to provide a digital item transaction to a streamer. The interface 1200 may support the viewer to randomly select a digital item transaction. FIG. 12 will explain a method of displaying a game function corresponding to a randomly selected digital item transaction. For example, the interface 1200 shown in FIG. 12 may represent an interface after the selection button 1130 for a random game function included in the interface 1100 of FIG. 11 is selected.

The interface 1200 may include an image 1210 indicating an application status of the selected game function, information 1220 about a probability of the selected game function being randomly drawn, identification information 1230 of the selected game function, a selection button 1240 for a random game function, a button 1250 for not applying the selected game function and randomly selecting a game function again, a button 1260 for selecting whether to make a sponsor's identification information anonymous when sponsoring, a button 1270 for selecting whether to skip an animation shown during random selection of a game function, a button 1280 for providing a detailed list of digital item transaction types, and a button 1290 for providing a history of game functions sponsored by a user.

According to an example, in the case of the button 1250 for not applying the selected game function and randomly selecting a game function again, information notifying that a discount amount is applied may be displayed adjacent to the button 1250, and information (e.g., a timer) notifying a selectable time of the button 1250 may be displayed within the button 1250.

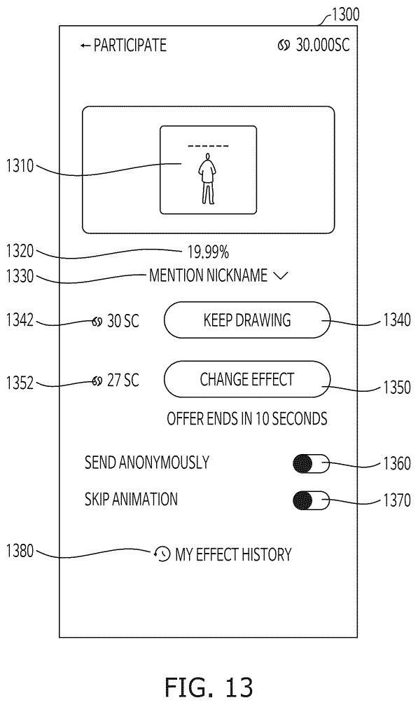

FIG. 13 is a diagram for explaining another method of displaying a randomly selected digital item transaction according to an example of the present disclosure. Referring to FIG. 13, a viewer terminal may provide an interface 1300 that supports a viewer to provide a digital item transaction to a streamer. The interface 1300 may support the viewer to randomly select a digital item transaction. FIG. 13 will explain a method of displaying a game function corresponding to a randomly selected digital item transaction. For example, the interface 1300 shown in FIG. 13 may represent an interface after the selection button 1130 for a random game function included in the interface 1100 of FIG. 11 is selected.

The interface 1300 may include an image 1310 indicating an application status of the selected game function, information 1320 about a probability of the selected game function being randomly drawn, identification information 1330 of the selected game function, a selection button 1340 for a random game function, information 1342 about a digital item transaction amount of the random game function, a change button 1350 for the game function, information 1352 about a digital item transaction amount according to the change of the game function, a button 1360 for selecting whether to make a sponsor's identification information anonymous when sponsoring, a button 1370 for selecting whether to skip an animation shown during random selection of a game function, and a button 1380 for providing a history of game functions sponsored by a user.

According to an example, in the case of the change button 1350 for the game function, information (e.g., a timer) notifying a selectable time of the button 1350 may be displayed adjacent to the button 1350.

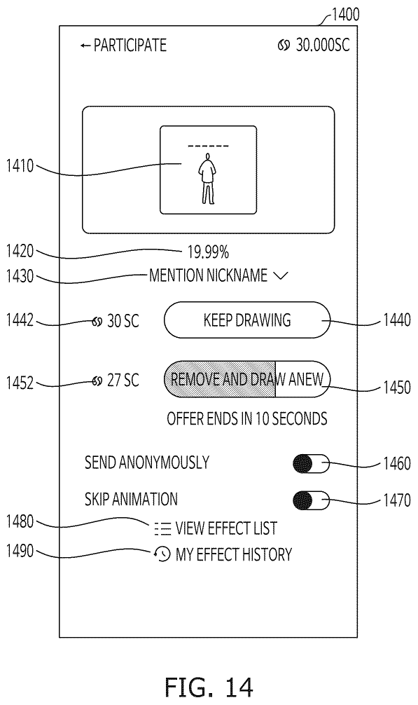

FIG. 14 is a diagram for explaining yet another method of displaying a randomly selected digital item transaction according to an example of the present disclosure. Referring to FIG. 14, a viewer terminal may provide an interface 1400 that supports a viewer to provide a digital item transaction to a streamer. The interface 1400 may support the viewer to randomly select a digital item transaction. FIG. 14 will explain a method of displaying a game function corresponding to a randomly selected digital item transaction. For example, the interface 1400 shown in FIG. 14 may represent an interface after the selection button 1130 for a random game function included in the interface 1100 of FIG. 11 is selected.

The interface 1400 may include an image 1410 indicating an application status of the selected game function, information 1420 about a probability of the selected game function being randomly drawn, identification information 1430 of the selected game function, a selection button 1440 for a random game function, information 1442 about a digital item transaction amount of the random game function, a button 1450 for not applying the selected game function and randomly selecting a game function again, information 1452 about a digital item transaction amount according to the reselection of the game function, a button 1460 for selecting whether to make a sponsor's identification information anonymous when sponsoring, a button 1470 for selecting whether to skip an animation shown during random selection of a game function, a button 1480 for providing a detailed list of digital item transaction types, and a button 1490 for providing a history of game functions sponsored by a user.

According to an example, in the case of the button 1450 for not applying the selected game function and randomly selecting a game function again, an animation notifying a selectable time of the button 1450 may be applied to the button 1450. For example, an animation in which the color of the button 1450 gradually changes to another color over time may be applied to the button 1450.

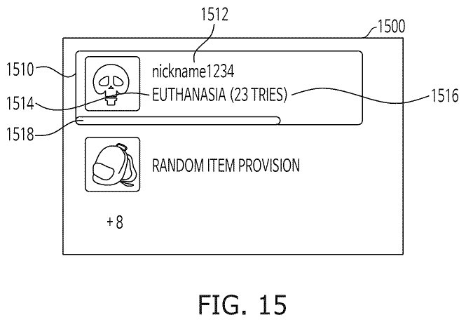

FIG. 15 is a diagram for explaining a method of displaying an object including information associated with a digital item transaction according to an example of the present disclosure. Referring to FIG. 15, a streamer terminal may display an object 1500 including information associated with a digital item transaction overlapping a screen displaying game content (e.g., a broadcast screen). The object 1500 including the information associated with the digital item transaction may include a list having at least one game function to be applied to the game content as an item 1510. Each item 1510 may include at least one of an image 1510 representing the game function, identification information 1512 of a sponsor (e.g., a sponsor's nickname), identification information 1514 of the game function, or information 1518 notifying a time until the game function is applied to the game content (e.g., remaining time).

According to an example, the identification information 1514 of the game function may include information 1516 about the number of times until the selected game function was selected. For example, when a sponsor randomly selects a game function, the game function desired by the sponsor may not be selected. At this time, the sponsor may reselect a game function by selecting the buttons 1250, 1450 for not applying the selected game function and randomly selecting a game function again, as shown in FIGS. 12 and 14, or the change button 1350 for the game function as shown in FIG. 13. Information 1516 about the number of times until such a reselected game function is selected may be included in the identification information 1514 of the game function.

According to an example, the information 1518 notifying the time until the game function is applied to the game content may be counted in a way that the remaining time decreases, like a timer, and may be displayed in at least one of a clock format or a progress bar format.

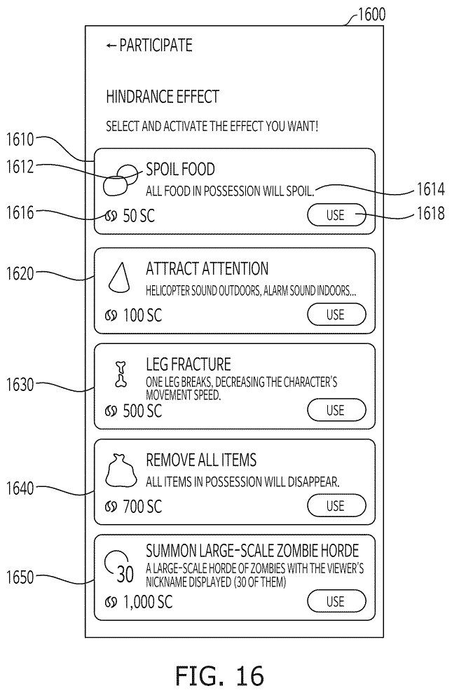

FIG. 16 is a diagram for explaining a method of providing a list of digital item transactions according to an example of the present disclosure. Referring to FIG. 16, a viewer terminal may provide an interface 1600 that supports a viewer to provide a digital item transaction to a streamer. The interface 1600 may display a list of digital item transactions that affect game content. For example, the interface 1600 may include a list having game functions that affect game content as items 1610, 1620, 1630, 1640, 1650. Each item 1610, 1620, 1630, 1640, 1650 may include an image representing a game function, identification information 1612 of the game function, contents 1614 of the game function, information 1616 about a digital item transaction amount of the game function, and a selection button 1618 for the game function.

According to an example, the items 1610, 1620, 1630, 1640, 1650 included in the list of digital item transactions that affect game content may be determined by a system or a streamer. In addition, the information 1616 about the digital item transaction amount of the game function may also be determined by the system or the streamer.

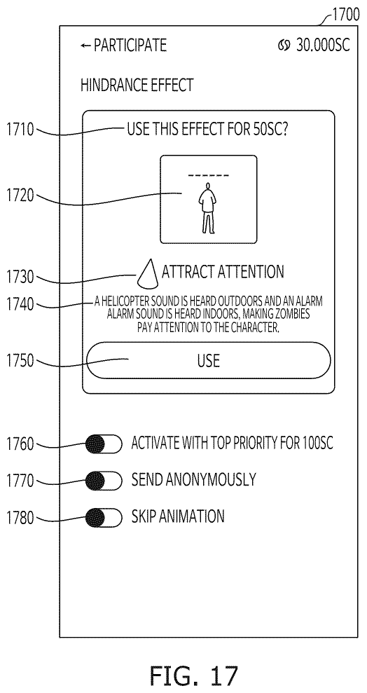

If the selection button 1618 for the game function included in any one item 1610 among the items 1610, 1620, 1630, 1640, 1650 included in the list is selected, as shown in FIG. 17, the interface 1700 may support the provision of information associated with the selected digital item transaction.

FIG. 17 is a diagram for explaining a method of displaying a digital item transaction selected from a list according to an example of the present disclosure. Referring to FIG. 17, a viewer terminal may provide an interface 1700 that supports a viewer to provide a digital item transaction to a streamer. The interface 1700 may include information associated with a digital item transaction corresponding to any one game function selected from a list having game functions that affect game content as items.

The interface 1700 may include information 1710 about a digital item transaction amount of the selected game function, an image 1720 indicating an application status of the selected game function, identification information 1730 of the selected game function, contents 1740 of the selected game function, a selection button 1750 for the selected game function, a button 1760 for selecting whether to preferentially apply the selected game function, a button 1770 for selecting whether to make a sponsor's identification information anonymous when sponsoring, and a button 1780 for selecting whether to skip an animation shown during selection of a game function.

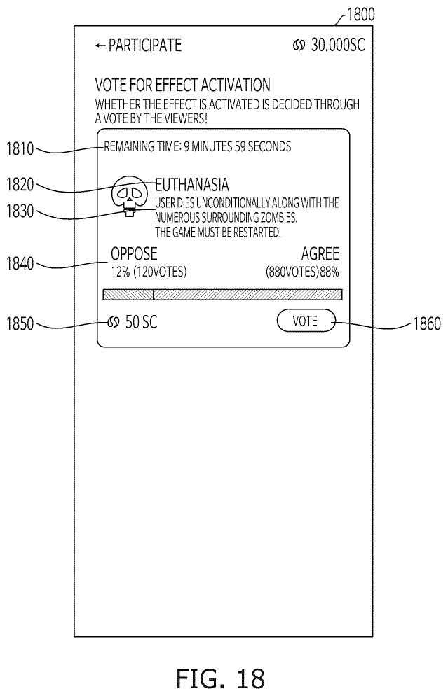

FIG. 18 is a diagram for explaining a method of displaying a digital item transaction corresponding to a game function performed according to a result of voting determined by digital item transaction over a predetermined period of time, according to an example of the present disclosure. Referring to FIG. 18, a viewer terminal may provide an interface 1800 that supports a viewer to provide a digital item transaction to a streamer. The interface 1800 may include information associated with a digital item transaction corresponding to any one game function selected from a list having game functions that affect game content as items.

Meanwhile, a game function that affects game content may include a function performed according to a result of voting determined by digital item transaction over a predetermined period of time. For example, in the case of a game function that forcibly ends a game during game play (e.g., a function that kills a streamer's character), because the game function can interfere with the flow of game play, the game function may cause discomfort to many viewers. As such, in the case of a specific game function, the specific game function may be performed according to a result of voting determined by digital item transaction over a predetermined period of time, by the setting of a system or a streamer. At this time, the interface 1800 may include information 1810 notifying a voting deadline, identification information 1820 of a game function for which voting is being conducted, contents 1830 of the game function for which voting is being conducted, information 1840 notifying a progress status of the vote, information 1850 about a digital item transaction amount for participating in the vote, and a button 1860 for participating in the vote.

According to an example, the information 1810 notifying the voting deadline may be counted in a way that the remaining time decreases, like a timer. At this time, if the remaining time is less than a predetermined time (e.g., 1 minute), the information 1810 notifying the voting deadline may be changed to a specific text (e.g., “Closing soon”). In addition, the remaining time may be a sum of a time arbitrarily set by the system (e.g., 1 second to 60 seconds) and an actual remaining time (e.g., 1 minute). In addition, the information 1840 notifying the progress status of the vote may include information about the number (and/or ratio) of digital item transactions in favor of applying the game function and the number (and/or ratio) of digital item transactions against applying the game function. The ratio of digital item transactions in favor of applying the game function and digital item transactions against applying the game function may be expressed as a graph showing an occupancy ratio.

According to an example, a game function that affects game content may include a function performed when a predetermined digital item transaction amount is achieved together with at least one other digital item transaction. For example, in the case of a game function that has a huge impact on game play, by the setting of a system or a streamer, it may be possible to support the application to game content to be determined by a plurality of sponsors. At this time, the method determined by the plurality of sponsors may include not only the above-described method by voting but also a method by achieving a predetermined digital item transaction amount. At this time, the interface 1800 may include information notifying a digital item transaction deadline, identification information of a game function, contents of the game function, information about a digital item transaction amount set to apply the game function, information about a digital item transaction amount accumulated so far, information about a digital item transaction amount for participating in the corresponding digital item transaction, and a button for participating in the corresponding digital item transaction.

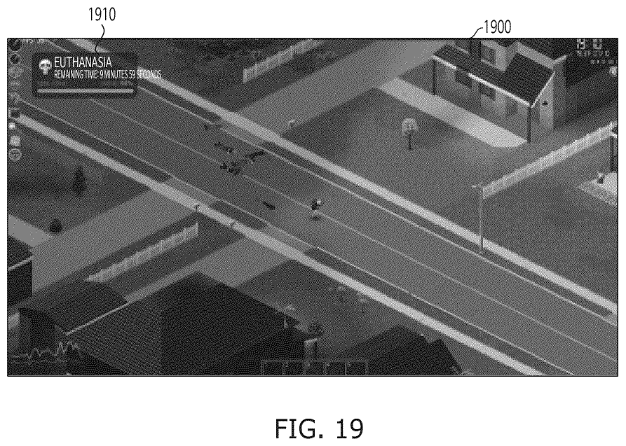

FIG. 19 is a diagram for explaining a method of displaying an object associated with a game function performed according to a result of voting determined by digital item transaction over a predetermined period of time, according to an example of the present disclosure. Referring to FIG. 19, a streamer terminal may display an object 1910 including information associated with a digital item transaction overlapping a screen 1900 displaying game content (e.g., a broadcast screen). The object 1910 including the information associated with the digital item transaction may include an object associated with a game function performed according to a result of voting determined by digital item transaction over a predetermined period of time. For example, the object 1910 including the information associated with the digital item transaction may include identification information of a game function for which voting is being conducted, information notifying a voting deadline, and information notifying a progress status of the vote. The information notifying the progress status of the vote may include information about the number (and/or ratio) of digital item transactions in favor of applying the game function and the number (and/or ratio) of digital item transactions against applying the game function.

According to an example, if a game function that affects game content is a function performed when a predetermined digital item transaction amount is achieved together with at least one other digital item transaction, the object 1910 including information associated with the digital item transaction may include identification information of the game function, information notifying a digital item transaction deadline, information about a digital item transaction amount set to apply the game function, and information about a digital item transaction amount accumulated so far.

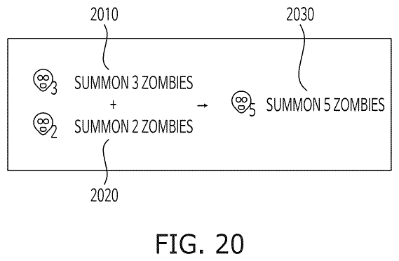

FIG. 20 is a diagram for explaining a method of integrating a plurality of game functions having the same function according to an example of the present disclosure. Referring to FIG. 20, a digital item transaction mediation server (e.g., the electronic device 100 of FIG. 1) may integrate a plurality of game functions 2010, 2020 having the same function. For example, if a plurality of game functions 2010, 2020 waiting to be applied to game content have the same function, the digital item transaction mediation server may integrate the plurality of game functions 2010, 2020 into a game function 2030 with a greater application intensity of the same function. Specifically, as shown in FIG. 20, if a first game function 2010 is a function of adding n (e.g., 2) game objects (e.g., zombies) to the game content, and a second game function 2020 is a function of adding m (e.g., 3) identical game objects to the game content, the digital item transaction mediation server may integrate the first game function 2010 and the second game function 2020 into a third game function 2030 that adds (n+m) game objects to the game content.

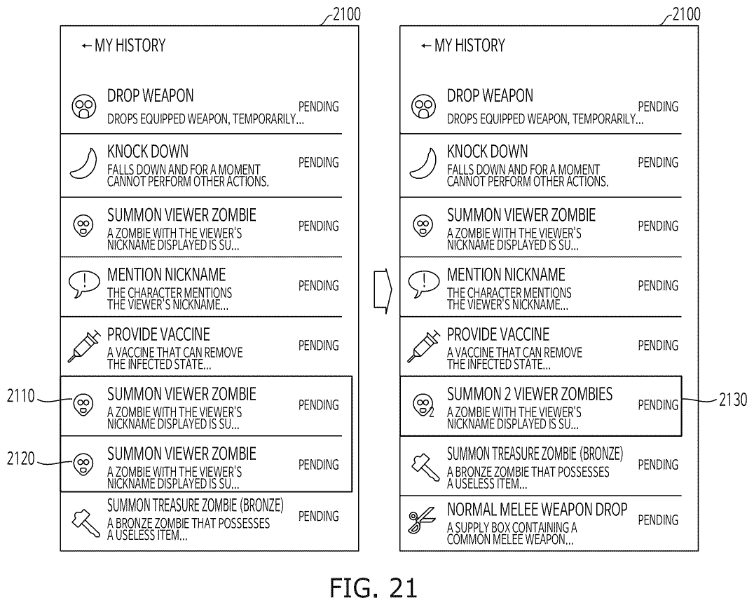

FIG. 21 is a diagram for explaining a method of integrating a plurality of game functions having the same function from a sponsored list according to an example of the present disclosure. Referring to FIG. 21, when a digital item transaction mediation server (e.g., the electronic device 100 of FIG. 1) receives a signal associated with a digital item transaction from a viewer terminal, the digital item transaction mediation server may add an object 2110, 2120 including information associated with the digital item transaction to a digital item transaction information list 2100. Here, the digital item transaction information list 2100 may include an object 2110, 2120 including information associated with at least one digital item transaction waiting to be applied to game content.

The digital item transaction mediation server may integrate a plurality of game functions having the same function. For example, if a plurality of game functions waiting to be applied to game content have the same function, the digital item transaction mediation server may integrate the plurality of game functions into a game function with a greater application intensity of the same function.

According to an example, if there are duplicate game functions that overlap back and forth in the order in which digital item transactions were received among a plurality of objects included in the digital item transaction information list 2100, the digital item transaction mediation server may integrate the duplicate game functions. For example, if a first object 2110 and a second object 2120 corresponding to a first game function and a second game function, respectively, having the same function are included in the digital item transaction information list 2100 in back-and-forth order, the digital item transaction mediation server may integrate the first game function and the second game function into a third game function with a greater application intensity of the same function. In addition, the digital item transaction mediation server may change the first object 2110 and the second object 2120 to a third object 2130 corresponding to the integrated third game function.

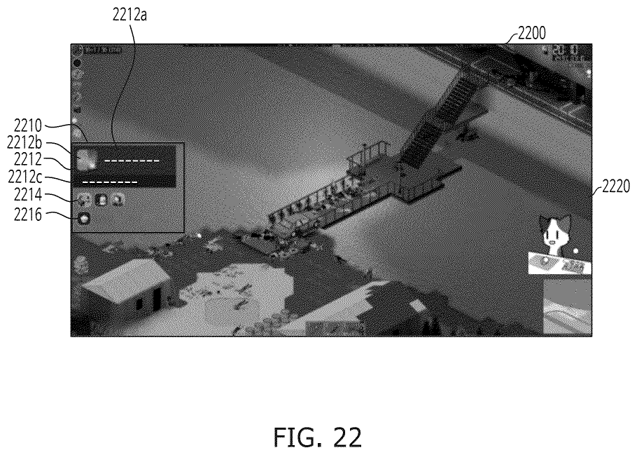

FIG. 22 is a diagram for explaining a broadcast screen including game content according to an example of the present disclosure. Referring to FIG. 22, a streamer terminal may display an object 2210 including information associated with a digital item transaction overlapping a screen 2200 displaying game content (e.g., a broadcast screen). At this time, the streamer terminal may include the object 2210 including the information associated with the digital item transaction only in the broadcast screen 2200 and not in a game screen, similar to an object 2220 associated with the progress of the broadcast (e.g., a real-time shooting screen of a broadcast camera, a streamer's broadcast character image, chat content, etc.). For example, the streamer terminal may display the object 2210 including the information associated with the digital item transaction in a widget format on the broadcast screen 2200.

The object 2210 including the information associated with the digital item transaction may include a list having at least one game function to be applied to the game content as items 2212, 2214, 2216. At this time, among the items 2212, 2214, 2216 included in the list, the item 2212 to be applied next in order may include at least one of identification information 2212a of the game function, information 2212b notifying a time until the game function is applied to the game content (e.g., remaining time), or a sponsor's identification information (e.g., a sponsor's nickname) and a message 2212c. According to an example, the information 2212b notifying the time until the game function is applied to the game content may be counted in a way that the remaining time decreases, like a timer, and may be displayed in at least one of a clock format or a progress bar format.

Among the items 2212, 2214, 2216 included in the list, the most recently added item 2216 may include an image representing the game function and the sponsor's identification information. In addition, among the items 2212, 2214, 2216 included in the list, the remaining item 2214, excluding the most recently added item 2216 and the item 2212 to be applied next in order, may include an image representing the game function.

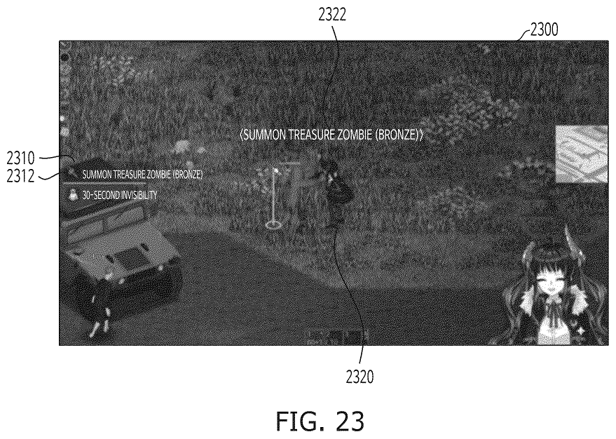

FIG. 23 is a diagram for explaining a method of displaying identification information of a sponsor and contents of a game function in an area adjacent to a user's character included in game content according to an example of the present disclosure. Referring to FIG. 23, a streamer terminal may display an object 2310 including information associated with a digital item transaction overlapping a screen 2300 displaying game content (e.g., a broadcast screen). At this time, the streamer terminal may include the object 2310 including the information associated with the digital item transaction only in the broadcast screen 2300 and not in a game screen, similar to an object associated with the progress of the broadcast (e.g., a real-time shooting screen of a broadcast camera, a streamer's broadcast character image, chat content, etc.).

The object 2310 including the information associated with the digital item transaction may include a list having at least one game function to be applied to the game content as an item 2312. At this time, when the game function of the item 2312 included in the list is applied to the game content, an object 2322 including the sponsor's identification information and the contents of the applied game function may be displayed in an area adjacent to a user's character 2320 included in the game content. For example, the object 2322 including the sponsor's identification information and the contents of the applied game function may be displayed above the head of the character 2320.

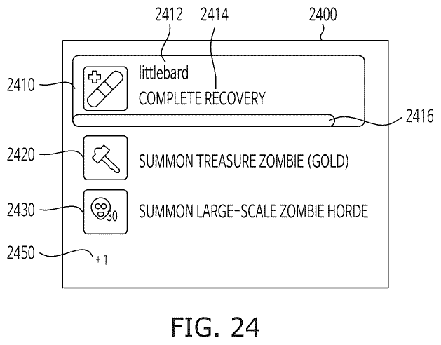

FIG. 24 is a diagram for explaining another method of displaying an object including information associated with a digital item transaction according to an example of the present disclosure. Referring to FIG. 24, a streamer terminal may display an object 2400 including information associated with a digital item transaction overlapping a screen displaying game content (e.g., a broadcast screen). The object 2400 including the information associated with the digital item transaction may include a list having at least one game function to be applied to the game content as items 2410, 2420, 2430, 2450. Each item 2410 may include at least one of an image representing the game function, identification information 2412 of a sponsor (e.g., a sponsor's nickname), identification information 2414 of the game function, or information 2416 notifying a time until the game function is applied to the game content (e.g., remaining time).

According to an example, the information 2416 notifying the time until the game function is applied to the game content may be counted in a way that the remaining time decreases, like a timer, and may be displayed in at least one of a clock format or a progress bar format.

According to an example, if the number of game functions to be applied to the game content, that is, the number of game functions waiting to be applied, exceeds a predetermined number, the items of the game functions corresponding to the excess number may be simplified and displayed as a single item 2450. At this time, the simplified item 2450 may be displayed with a specific symbol (e.g., “+”) and a number corresponding to the excess number (e.g., 2) (e.g., “+2”). Then, if some of the game functions of the items 2410, 2420, 2430, 2450 included in the list are applied and the number of game functions waiting to be applied does not exceed the predetermined number, the simplified item 2450 may be deleted.

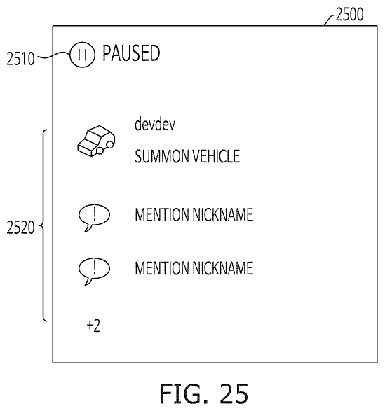

FIG. 25 is a diagram for explaining a method of indicating a temporary pause of game content or a streamer terminal according to an example of the present disclosure. Referring to FIG. 25, a streamer terminal may display an object 2500 including information associated with a digital item transaction overlapping a screen displaying game content (e.g., a broadcast screen). The object 2500 including the information associated with the digital item transaction may include a list having at least one game function to be applied to the game content as an item 2520.

According to an example, if a game that was in progress is temporarily paused or a first streamer terminal that transmits a game screen stops, a second streamer terminal that transmits a broadcast screen, that is, a streamer terminal that displays the object 2500 including the information associated with the digital item transaction, may include information 2510 notifying that the game or the streamer terminal is temporarily paused in the object 2500 including the information associated with the digital item transaction.

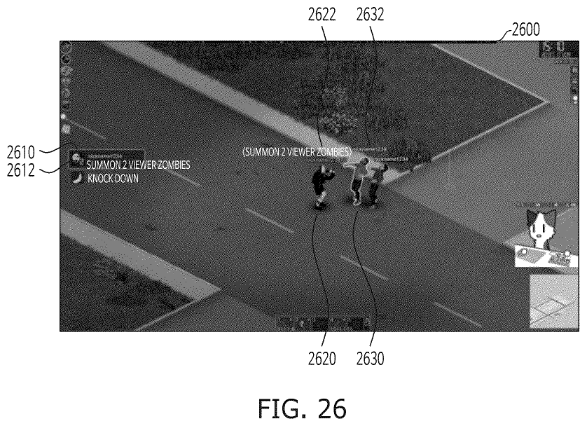

FIG. 26 is a diagram for explaining a method of adding a game object having a name corresponding to identification information of a sponsor to game content according to an example of the present disclosure. Referring to FIG. 26, a streamer terminal may display an object 2610 including information associated with a digital item transaction overlapping a screen 2600 displaying game content (e.g., a broadcast screen). At this time, the streamer terminal may include the object 2610 including the information associated with the digital item transaction only in the broadcast screen 2600 and not in a game screen, similar to an object associated with the progress of the broadcast (e.g., a real-time shooting screen of a broadcast camera, a streamer's broadcast character image, chat content, etc.).

The object 2610 including the information associated with the digital item transaction may include a list having at least one game function to be applied to the game content as an item 2612. At this time, when the game function of the item 2612 included in the list is applied to the game content, an object 2622 including the sponsor's identification information and the contents of the applied game function may be displayed in an area adjacent to a user's character 2620 included in the game content. For example, the object 2622 including the sponsor's identification information and the contents of the applied game function may be displayed above the head of the character 2620.

According to an example, if the applied game function is a function of adding a game object 2630 (e.g., a zombie) to the game content, the game object 2630 added to the game content may be created with a name 2632 corresponding to the sponsor's identification information.

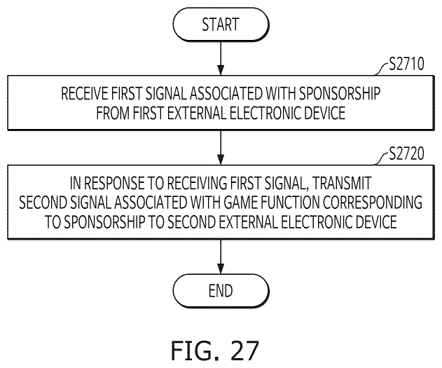

FIG. 27 is a diagram for explaining a digital item transaction mediation method according to an example of the present disclosure. Referring to FIG. 27, a processor of an electronic device for digital item transaction mediation (e.g., the electronic device 100 of FIG. 1) may, in step S2710, receive a first signal associated with a digital item transaction from a first external electronic device. Here, the first external electronic device may be an electronic device of a viewer who provides a digital item transaction to a streamer, that is, a viewer terminal. For example, the processor may receive a request signal for a digital item transaction that affects streaming game content from the viewer terminal.

In step S2720, the processor may, in response to receiving the first signal, transmit a second signal associated with a game function corresponding to the digital item transaction to a second external electronic device. Here, the second external electronic device may be an electronic device of a streamer who provides game content, that is, a streamer terminal. Alternatively, the second external electronic device may be a game server that provides game content. For example, the processor may transmit a signal associated with a game function applied to the game content to the streamer terminal or the game server that provides the game content, based on a digital item transaction request received from the viewer.

Then, upon receiving the signal associated with the game function, the second external electronic device may apply the game function to the game content. The game function may include a function of changing at least one attribute (e.g., health, movement speed, field of view, etc.) of a user's character or a game object (e.g., a mob) included in the game content, a function of adding a game item (e.g., a weapon) that the user's character can use to the game content, a function of adding a game object to the game content, and the like. At this time, a game object added to the game content may be created with a name corresponding to the sponsor's identification information.

According to an example, the game function may be applied to the game content when a predetermined time has elapsed after receiving the signal associated with the game function. For example, the game function may be applied to the game content with a grace period of a predetermined time after the streamer recognizes the game function to be applied to the game content. In addition, if there is another game function waiting to be applied due to another digital item transaction, the game function may be applied to the game content after the other waiting game function is applied. At this time, the time for the game function to be applied, that is, a predetermined time counted after receiving the signal associated with the game function, may start counting after the other waiting game is applied. For example, the game function may be applied to the game content when a predetermined time has elapsed after the other waiting game is applied.

According to an example, the game function may be sequentially applied to the game content along with other game functions waiting to be applied. For this purpose, a signal for applying the game function may be stored and managed in a queue-type data structure. In addition, at least one game function to be applied to the game content may be added to a list and managed.

According to an example, information associated with the digital item transaction may be exposed (e.g., displayed) on a broadcast screen, that is, a screen including the game content, until the game function corresponding to the digital item transaction is applied to the game content. For example, an object including information associated with the digital item transaction may be displayed overlapping at least a partial area of the screen including the game content. Here, the information associated with the digital item transaction may include at least one of identification information of the sponsor, contents of the game function corresponding to the digital item transaction, or a time until the game function corresponding to the digital item transaction is applied (e.g., remaining time). At this time, the time until the game function is applied may be counted in a way that the remaining time decreases, like a timer, and may be displayed in at least one of a clock format or a progress bar format. In addition, the object including the information associated with the digital item transaction is an object that is included only in the broadcast screen and not in the game screen, similar to an object associated with the progress of the broadcast, for example, a real-time shooting screen of a broadcast camera, a streamer's broadcast character image, chat content, etc., and may be a broadcast widget displayed in a widget format on the broadcast screen.

According to an example, when the game function corresponding to the digital item transaction is applied to the game content, the identification information of the sponsor and the contents of the game function corresponding to the digital item transaction may be displayed in an area adjacent to the user's character included in the game content.

In some examples, a digital item transaction mediation method performed by at least one processor includes receiving a first signal associated with a digital item transaction from a first external electronic device, and transmitting, in response to receiving the first signal, a second signal associated with a first game function corresponding to the digital item transaction to a second external electronic device, wherein the first game function is applied to game content provided by the second external electronic device.

In some examples, a first object including information associated with the digital item transaction may be displayed overlapping at least part of a screen displaying the game content.

In some examples, the information associated with the digital item transaction may include at least one of identification information of a sponsor, contents of the first game function, or a time until the first game function is applied.

In some examples, the first object may be generated at the second external electronic device in response to receiving the second signal.

In some examples, the digital item transaction mediation method may further include transmitting, in response to receiving the first signal, a third signal associated with application of the first game function to a third external electronic device connected to the second external electronic device. The first object may be generated at the third external electronic device in response to receiving the third signal.

In some examples, the game content to which the first game function is applied may be transmitted from the second external electronic device to a third external electronic device.

In some examples, the digital item transaction mediation method may further include transmitting a third signal associated with application of the first game function to the third external electronic device. The first object may be generated at the third external electronic device in response to receiving the third signal.

In some examples, the digital item transaction mediation method may further include transmitting a third signal associated with application of the first game function to a fourth external electronic device connected to the third external electronic device. The first object may be generated at the fourth external electronic device in response to receiving the third signal.

In some examples, if a third signal associated with another digital item transaction is received before receiving the first signal, and before a second game function corresponding to the other digital item transaction is applied to the game content, the first object may be added to a list including a second object may include information associated with the other digital item transaction.

In some examples, if the first game function and the second game function are of a same functional type, the first game function and the second game function may be integrated into a third game function of the same functional type having a greater application intensity, and instead of adding the first object to the list, the second object previously included in the list may be changed into a third object corresponding to the third game function.

In some examples, if the first game function is a function performed according to a result of voting determined by digital item transaction over a predetermined period of time, the first object may include contents of the voting.

In some examples, if the first game function is a function performed upon reaching a predetermined digital item transaction amount together with at least one other digital item transaction, the first object may include a currently accumulated digital item transaction amount.

In some examples, when the first game function is applied to the game content, identification information of a sponsor and contents of the first game function may be displayed in an area adjacent to a user's character included in the game content.

In some examples, the first game function may include a function of adding a game object having a name corresponding to identification information of a sponsor to the game content.

In some examples, a non-transitory computer-readable recording medium storing computer-readable instructions that, when executed by at least one processor, cause the at least one processor to receive, via a communication circuit, a first signal associated with a digital item transaction from a first external electronic device, transmit, in response to receiving the first signal, via the communication circuit, a second signal associated with a first game function corresponding to the digital item transaction to a second external electronic device, wherein the first game function is applied to game content provided by the second external electronic device.

In some examples, an electronic device includes a communication circuit, a memory, and at least one processor connected to the communication circuit and the memory and configured to execute computer-readable instructions stored in the memory, wherein the at least one processor is configured to receive, via the communication circuit, a first signal associated with a digital item transaction from a first external electronic device, transmit, in response to receiving the first signal, via the communication circuit, a second signal associated with a first game function corresponding to the digital item transaction to a second external electronic device, wherein the first game function is applied to game content provided by the second external electronic device.

The above-described flowchart and the above-described explanation are only an example, and may be implemented differently in some examples. For example, in some examples, the order of each step may be changed, some steps may be repeated, some steps may be omitted, or some steps may be added.

The above-described method may be provided as a computer program stored in a computer-readable recording medium for execution on a computer. The medium may be one that continuously stores a computer-executable program, or temporarily stores the computer-executable program for execution or download. In addition, the medium may be various recording means or storage means in the form of a single or several combined hardware, and is not limited to a medium directly connected to a certain computer system, but may be one that exists distributed on a network. Examples of the medium may include magnetic media such as a hard disk, a floppy disk, and a magnetic tape, optical recording media such as a CD-ROM and a DVD, a magneto-optical medium such as a floptical disk, and one configured to store program instructions, including a ROM, a RAM, a flash memory, and the like. In addition, other examples of the medium may include a recording medium or storage medium managed by an app store that distributes applications or a site, a server, etc. that supplies or distributes various other software.

The methods, operations, or techniques of the present disclosure may also be implemented by various means. For example, these techniques may be implemented in hardware, firmware, software, or a combination thereof. Those of ordinary skill in the art will understand that the various exemplary logical blocks, modules, circuits, and algorithm steps described in connection with the disclosure herein may be implemented as electronic hardware, computer software, or combinations of both. To clearly illustrate this interchangeability of hardware and software, various exemplary components, blocks, modules, circuits, and steps have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

In a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, a computer, or a combination thereof.

Accordingly, the various exemplary logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In a firmware and/or software implementation, the techniques may be implemented as instructions stored on a computer-readable medium, such as random access memory (RAM), read-only memory (ROM), non-volatile RAM (NVRAM), programmable read-only memory (PROM), erasable programmable read-only memory (EPROM), electrically erasable PROM (EEPROM), flash memory, a compact disc (CD), a magnetic or optical data storage device, and the like. The instructions may be executable by one or more processors, and may cause the processor(s) to perform certain aspects of the functionality described in the present disclosure.

When implemented in software, the above-described techniques may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes a compact disc (CD), a laser disc, an optical disc, a digital versatile disc (DVD), a floppy disk, and a Blu-ray disc where disks usually reproduce data magnetically, while discs reproduce data optically with lasers. Combinations of the above should also be included within the scope of computer-readable media.

A software module may reside in a RAM memory, a flash memory, a ROM memory, an EPROM memory, an EEPROM memory, registers, a hard disk, a removable disk, a CD-ROM, or any other form of storage medium known in the art. An exemplary storage medium may be coupled to a processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Although the embodiments described above have been described as utilizing aspects of the presently disclosed subject matter in one or more standalone computer systems, the present disclosure is not limited thereto and may be implemented in conjunction with any computing environment, such as a network or distributed computing environment. Furthermore, aspects of the subject matter in the present disclosure may be implemented in a plurality of processing chips or devices, and storage may be similarly affected across a plurality of devices. Such devices may include PCs, network servers, and portable devices.

Although the present disclosure has been described in connection with some embodiments in this specification, various modifications and changes can be made without departing from the scope of the present disclosure, which can be understood by a person of ordinary skill in the art to which the invention of the present disclosure belongs. In addition, such modifications and changes should be considered to fall within the scope of the claims attached to this specification.

What is claimed is:

1. A method performed by an apparatus comprising at least one processor, the method comprising:
receiving a first signal associated with a digital item transaction from a first external electronic device, wherein the digital item transaction corresponds to a first game function of a first game application executed on a second external electronic device;
transmitting, in response to receiving the first signal, a second signal associated with the first game function to the second external electronic device, wherein the second signal causes a modification of the first game function of the first game application executed on the second external electronic device; and
causing the first external electronic device to output a video streaming of the first game application executed on the second external electronic device, wherein the modification of the first game function is applied in the video streaming of game content of the first game application executed on the second external electronic device.

2. The method as claimed in claim 1, wherein a first object is displayed overlapping at least part of a screen displaying the video streaming of the game content of the first game application executed on the second external electronic device, and
wherein the first object comprises at least one of:
information associated with the digital item transaction; or
an indicator indicating the modification of the first game function.

3. The method as claimed in claim 2, wherein the information associated with the digital item transaction comprises at least one of identification information of an executing entity associated with the digital item transaction, modification contents of the first game function, or a time duration in which the modification of the first game function is applied.

4. The method as claimed in claim 2, wherein the first object is generated by the second external electronic device in response to receiving the second signal.

5. The method as claimed in claim 2, further comprising:
transmitting, in response to receiving the first signal, a third signal associated with the modification of the first game function to a third external electronic device connected to the second external electronic device,
wherein the first object is generated by the third external electronic device in response to receiving the third signal.

6. The method as claimed in claim 2, wherein the game content, of the first game application executed on the second external electronic device, to which the modification of the first game function is applied is transmitted from the second external electronic device to a third external electronic device.

7. The method as claimed in claim 6, further comprising:
transmitting a third signal associated with the modification of the first game function to the third external electronic device,
wherein the first object is generated by the third external electronic device in response to receiving the third signal.

8. The method as claimed in claim 6, further comprising:
transmitting a third signal associated with the modification of the first game function to a fourth external electronic device communicating with the third external electronic device,
wherein the first object is generated by the fourth external electronic device in response to receiving the third signal.

9. The method as claimed in claim 2, wherein, based on a third signal associated with a second digital item transaction being received before receiving the first signal, and before a modification of a second game function corresponding to the second digital item transaction being applied to the game content of the first game application executed on the second external electronic device, the first object is added to a list including a second object comprising information associated with the second digital item transaction.

10. The method as claimed in claim 9, wherein, based on the first game function and the second game function being of a same functional type, the first game function and the second game function are integrated into a third game function of the same functional type having a greater application intensity in an application of the third game function to the first game application executed on the second external electronic device, and
wherein instead of adding the first object to the list, the second object previously included in the list is changed into a third object corresponding to the third game function.

11. The method as claimed in claim 2, wherein, based on the first game function being a function performed according to a result of voting determined by at least one digital item transaction over a predetermined period of time, the first object comprises contents of the voting.

12. The method as claimed in claim 2, wherein, based on the first game function being a function performed upon reaching a predetermined amount of digital item transactions together with at least one other digital item transaction, the first object comprises a currently accumulated amount of digital item transactions.

13. The method as claimed in claim 1, wherein, based on the modification of the first game function being applied to the game content of the first game application executed on the second external electronic device, identification information of an executing entity of the digital item transaction and contents of the first game function are displayed in an area adjacent to a user character included in the game content.

14. The method as claimed in claim 1, wherein the modification of the first game function comprises modifying the game content by adding a game object having a name corresponding to identification information of an executing entity of the digital item transaction to the game content.

15. A non-transitory computer-readable recording medium storing computer-readable instructions that, when executed by at least one processor, cause:
receiving a first signal associated with a digital item transaction from a first external electronic device, wherein the digital item transaction corresponds to a first game function of a first game application executed on a second external electronic device;
transmitting, in response to receiving the first signal, the second signal associated with the first game function to a second external electronic device, wherein the second signal causes a modification of the first game function of the first game application executed on the second external electronic device; and
causing the first external electronic device to output a video streaming of the first game application executed on the second external electronic device, wherein the modification of the first game function is applied in the video streaming of game content of the first game application executed on the second external electronic device.

16. An electronic device comprising:
a communication circuit;
a memory; and
at least one processor coupled to the communication circuit and the memory and configured to execute computer-readable instructions stored in the memory, wherein the computer-readable instructions, executed by the at least one processor, are configured to cause the electronic device to:
receive, via the communication circuit, a first signal associated with a digital item transaction from a first external electronic device, wherein the digital item transaction corresponds to a first game function of a first game application executed on a second external electronic device;
in response to receiving the first signal, transmitting, via the communication circuit, a second signal associated with the first game function to the second external electronic device, wherein the second signal causes a modification of the first game function of the first game application executed on the second external electronic device; and
causing the first external electronic device to output a video streaming of the first game application executed on the second external electronic device, wherein the modification of the first game function is applied in the video streaming of game content of the first game application executed on the second external electronic device.
